(19) United States
(12) Patent Application Publication
(10) Pub. No.: US 2011/0154405 A1
(43) Pub. Date: Jun. 23, 2011

(54) VIDEO SEGMENT MANAGEMENT AND DISTRIBUTION SYSTEM AND METHOD

(75) Inventor: Estefano Emilio Isaias, Miami, FL (US)

(73) Assignee: Cambridge Markets, S.A.

(21) Appl. No.: 12/975,330

(22) Filed: Dec. 21, 2010

Related U.S. Application Data
(60) Provisional application No. 61/288,602, filed on Dec. 21, 2009.

(51) Int. Cl. H04N 5/445

(52) U.S. Cl. 725/53

(57) ABSTRACT

A video and video fragment management and distribution system utilizes a server and a user interface. The server stores a series of videos in the form of video fragments. Each video fragment has associated therewith a host of video fragment data stored in a manner enabling an end user viewer to easily and efficiently perform a Boolean type search, based on desirable video fragment characteristics defined by the data, in order to return a desired set of video fragments. The system provides the viewer with a variety of search criteria options, each having a plurality of identifiers for locating a desirable video fragment. Each search criteria identifier can be set as inclusive or exclusive. The system includes a rating feature allowing the user to submit a rating and view an average of submitted ratings. The viewer creates a playlist or series of playlists for viewing a continuous, user defined series of video fragments.

### CROSS-REFERENCE TO RELATED APPLICATION

This U.S. non-provisional patent application claims the benefit of co-pending U.S. provisional patent application Ser. No. 61/288,602, filed on Dec. 21, 2009, which is incorporated herein in its entirety.

### FIELD OF THE INVENTION

The present invention relates generally to video entertainment systems and methods. More particularly, the invention pertains to a system and method for creating, manipulating and distributing, video fragments to facilitate subsequent video fragment searching, organizing and viewing by an end user to optimize the user's viewing experience.

### BACKGROUND OF THE INVENTION

The rapid growth of distribution of audio-video content over the Internet has been staggering. Improvements in bi-directional video communication speeds and quality have enabled the proliferation of new features, such as video-on-demand (VOD), wherein end users can request specific videos for viewing.

One known distribution method provides a VOD purchasing and escrowing system. This system has some drawbacks; including susceptibility to system interruptions due to less than ideal video downloading. To ensure completeness of the transaction, the viewer escrows a deposit to ensure satisfactory delivery of the purchase.

Another existing distribution method provides a data entry template that allows the user to search for a specific video by entering categorical data and/or defining a scene type. For example, the scene can be identified by providing information relating to an individual, a location or an object, as well as defining the information type, such as general trivia, geographical, biographical, historical, numerical, dates/date ranges, medical, botanical, scientific, and any combination of categories to search for the desired video.

Another existing distribution method provides an interactive so-called Multiple Channel User Enrollment, Purchase Confirmation Transactional System with Fulfillment Response Feature for Video On Demand Cable Systems, wherein a shop on-demand computer server ultimately receives a “buy now” command along with a unique set identification (ID). In one embodiment, the set ID code is migration authorization code (MAC) for the set-top box (STB). In response to the buy now command, a determination is made whether the user-viewer ID code (either the set ID code for the STB or other user ID code) matches an approved list of user-viewer ID codes either on the shop on-demand computer server or on a list stored at a cable head end.

The current state of video distribution allows the end user to download and view a complete video based upon a viewer's search and selection. Video downloading utilizes bandwidth. Video providers must be cognizant of such bandwidth use when determining fee charges to end users. In certain viewing scenarios, an end user may desire to view only a portion, or segment, of a complete video. For example, in the adult entertainment video arena, a viewer may only be interested in viewing an ending segment, such as the so-called “money shot.” In the sports viewing arena, a viewer may only be interested in viewing one or more key plays, without having to sit through a video of an entire game or event. Accordingly, the ability for an end user to easily search, download, store and organize, and then control the playback of a desired video segment would be highly desirable.

Current video technology also fails to consider and utilize individual viewer habits, or collective viewer feedback, for aiding viewer selection of a video. Providing a video entertainment system that utilizes an individual's viewing habits, or collective viewer feedback/rating data, in order to aid in the selection or suggestion of future video viewing choices would be highly desirable.

Accordingly, there is an unmet need in the home video entertainment industry, and particularly the home video-on-demand industry, for a system and associated method of video distribution that enables viewers to easily find, store, manipulate and view preferred segments of existing videos in order to greatly improve the viewing experience. Preferably, such a system would incorporate features for aiding an end user viewer in efficiently finding desired content and tracking and utilizing an individual viewer's viewing habits, and/or the feedback of a pool of collective viewers, in order to aid the viewer's future viewing selections.

### SUMMARY OF THE INVENTION

The present invention overcomes existing drawbacks and limitations of the known art through the provision of a system, and associated methods, for creating, manipulating and distributing, video segments to facilitate subsequent video segment searching, organizing and viewing by an end user to optimize the user's viewing experience. The system is generally applicable for use in connection with virtually any type of video entertainment. However, for the purpose of clarity, the following descriptions are made with reference to a specific implementation; namely, with regard to the adult video entertainment industry. Many adult video viewers are interested in one or more particular segments (interchangeably referred to herein as “fragments”) of a video. Accordingly, it is not uncommon for viewers to fast forward through extended sections of the video in order to find portions of the video that they find most appealing. With that said, it will be apparent to those skilled in video entertainment industry that the invention has broad applicability, well beyond the adult video entertainment industry.

In accordance with a general embodiment, a video distribution system is provided for creating, manipulating and distributing video segments in a manner facilitating subsequent video segment searching, organizing and viewing by an end user in order to optimize the viewing experience, in which the video distribution system comprises:
(a) a video distribution center, including a database server;
(b) at least one search index file stored on the database server and including a series of video content related identifiers;
(c) a length of video containing a continuous stretch of video content partitioned into a series of consecutive individual video segments, each video segment stored on the database server as an individual video segment file;
(d) each said video segment file having associated therewith information/values corresponding to the video content related identifiers of the search index file;
(e) an end user viewing interface remote from, but in two-way communication with, the video distribution center, the viewing interface comprising:
   (1) computer operated software including a graphical user interface;
   (2) a user interface control unit in communication with the computer operated software, the user interface control unit facilitating end user selection of preferred information/values corresponding to at least some of the video content related identifiers of the search index file;
   (3) a search routine facilitating selection by the end user viewer of said preferred information/values corresponding to said video content related identifiers, wherein the preferred information/values are used to determine at least one viewer preferred video segment; and
(e) an output interface for displaying said at least one viewer preferred video segment on a viewer display.

In one aspect, the information/values corresponding to the video content related identifiers of the search index file may include: production-related information (e.g., Studio, Production Company, etc.), video content related information (e.g., Video Title, Nature/Category of Sexual Content, etc.), and actor information (e.g., Name, Physical Characteristics/Attributes, etc.).

In another aspect, the end user selection of preferred information/values corresponding to at least some of the video content related identifiers of the search index file may include positive inclusion of information/values and negative exclusion of information/values.

In another aspect, the video segments are displayed in a manner enabling the end user to view a series of segments in order to efficiently scan through a search result set. Additionally, video or video fragment information may be presented to the viewer when the respective video or video fragment is selected. The information can include the video title; the length of the video and/or video fragments, associated starring actors, associated identifiers, studio and production company information, video release date, purchase cost, viewer's rating, and whether the video or video fragment is listed in a customer's “watched” playlist, “favorites” playlist, or user library, for example.

In another aspect, the end user viewer can sort a returned set of results by title, date of release, and viewer rating.

In another aspect, the system allows the user to pause the playback of a first video fragment while playing a second video fragment.

In another aspect, the system allows the user to upload a rating to the database server, where it may be stored and associated with the video title, the video fragment, and the user rating the video, thereby enabling the user to change the rating. Preferably, the information is stored within a system ratings table on the distribution center server.

In another aspect, the system allows the user to maintain a playlist on the distribution center server. The playlist can be a “watched” playlist, a “favorites” playlist and a “stored” playlist or library. The user can add, copy, delete, and move videos and video fragments from playlist to playlist.

In another aspect, the system allows the viewer to store a starting point and an ending point of a video or video fragment, enabling the viewer to repeatably view the same portion of the video or video fragment.

In another aspect, the user interface is preferably a remote control device.

In another aspect, the system allows the user to adjust the video quality transferred from the distribution center server to the system receiver at any point, including during the video playback. The distribution center server stores the video in a multitude of pixel densities, allowing for changes in the data transfer rates.

In another aspect, the system can include an entry grid displayed for aiding the user in entering alphanumeric characters.

In another aspect, the system enables a user to search for particular starring actors. Upon review of the returned result set, the viewer can efficiently visually scan through a series of stars, whereby each view provides a displayed photographic image of the star, the stage and/or given name of the star, and other information pertaining to the star, including, for example, birth date, birthplace, physical measurements and attributes, total quantity of scenes, and the like. The displayed information may contain the aforementioned identifiers associated with the star.

In another aspect, the system utilizes an automated end user viewer set-up routine to properly configure the system, including, for example, configuring the display settings, the network settings, and the like.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an elevation view of a controller interface unit in communication with an audio/video display;

FIG. 2 presents a rear, elevation view of the controller interface unit of FIG. 1, detailing the input and output interfaces;

FIG. 3 presents an elevation view of a remote control;

FIG. 4 presents an exemplary block diagram illustrating a video fragment index;

FIG. 5 presents an exemplary block diagram illustrating a distribution center portion of the system;

FIG. 6 presents an exemplary block diagram illustrating a viewer interface portion of the system;

FIG. 7 presents an exemplary block diagram illustrating various playlists and the respective interaction therebetween;

FIG. 8 presents a set up wizard graphical user interface (GUI);

FIG. 9 presents a monitor aspect selection screen;

FIG. 10 presents a network configuration screen;

FIG. 11 presents a network configuration screen, more specifically a WiFi configuration screen;

FIG. 12 presents a network configuration screen, more specifically a WiFi encryptions settings configuration screen;

FIG. 13 presents a network configuration screen, more specifically a WiFi password entry screen;

FIG. 14 presents a network configuration screen, more specifically a bandwidth connection speed entry/acceptance screen;

FIG. 15 presents an exemplary main menu screen;

FIG. 16 presents an exemplary main menu screen selecting a video view option;

FIG. 17 presents an exemplary main menu screen selecting a video view option, displaying the view subcategories listings;

FIG. 18 presents an exemplary main menu screen selecting a search view option, displaying the search options listings;

FIG. 19 presents a first exemplary category selection screen;

FIG. 20 presents a first exemplary category selection search results screen;

FIG. 21 presents a second exemplary category selection search results screen;

FIG. 22 presents an exemplary sequential video fragment viewing screen;

FIG. 23 presents a second exemplary category selection screen, the screen further presenting the category search results;

FIG. 24 presents a third exemplary category selection screen, the screen further presenting the category search results;

FIG. 25 present an exemplary video/video fragment interactive screen, allowing the user to change the download quality, change favorites or other library status, and provide a rating;

FIG. 26 presents an exemplary rating flow diagram;

FIG. 27 presents an exemplary video fragment cursory review screen;

FIG. 28 presents an exemplary title search screen;

FIG. 29 presents an exemplary star search screen, the screen further presenting the category search results and a hidden keyboard;

FIG. 30 presents an exemplary series search screen;

FIG. 31 presents an exemplary studio search screen;

FIG. 32 presents an exemplary main menu screen selecting a playlist view option, displaying the playlist options listings;

FIG. 33 presents an exemplary video fragment playlist management and preview screen;

FIG. 34 presents an exemplary watched video fragment management and preview screen;

FIG. 35 presents an exemplary video fragment rating entry screen;

FIG. 36 presents an exemplary video fragment rating entry verification screen;

FIG. 37 presents an exemplary main menu screen selecting a Live TV category and a view TV guide option;

FIG. 38 presents an exemplary main menu screen selecting a settings category and a TV output option;

FIG. 39 presents an exemplary main menu screen selecting an account category, illustrating the respective account subcategories listings; and

FIG. 40 presents an exemplary main menu screen selecting a lock category, which allows the user to lock the user interface software.

Like reference numerals refer to like parts throughout the several views of the drawings.

### DETAILED DESCRIPTION

Detailed implementations of the present invention are disclosed herein. It will be understood that the disclosed implementations are merely exemplary of the invention, which may be embodied in various and alternative forms. The figures are not necessarily to scale, and some features may be exaggerated or minimized to show details of particular embodiments, features, or elements. Specific structural and functional details, dimensions, or shapes disclosed herein are not limiting but serve as a basis for the claims and for teaching a person of ordinary skill in the art the described and claimed features of embodiments of the present invention. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

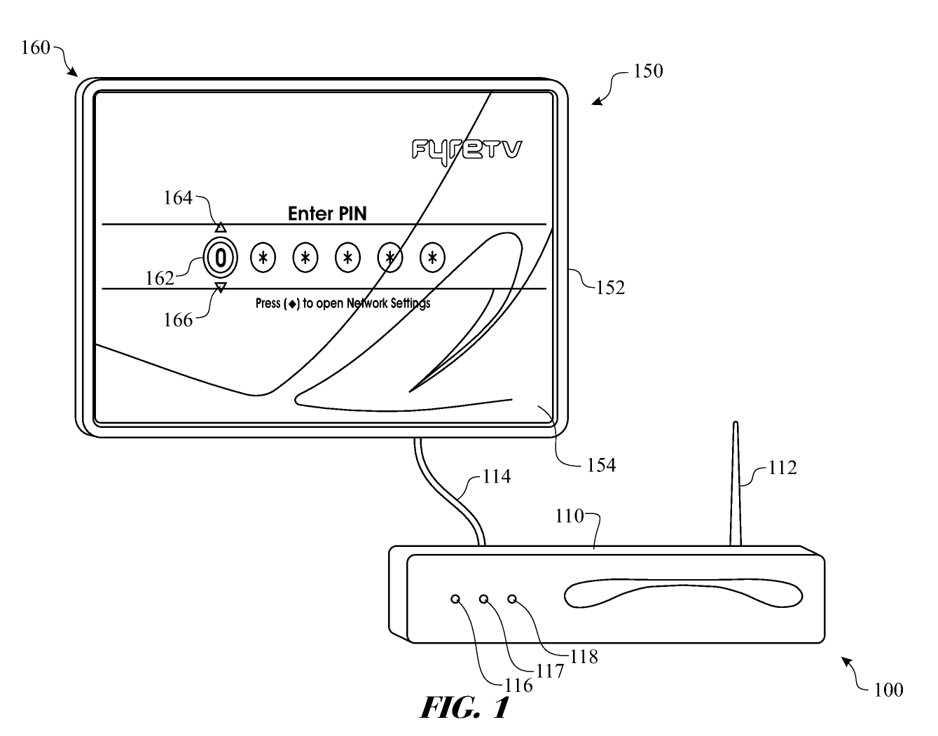

For purposes of description herein, the terms “upper,” “lower,” “left,” “rear,” “right,” “front,” “vertical,” “horizontal,” and derivatives thereof, shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

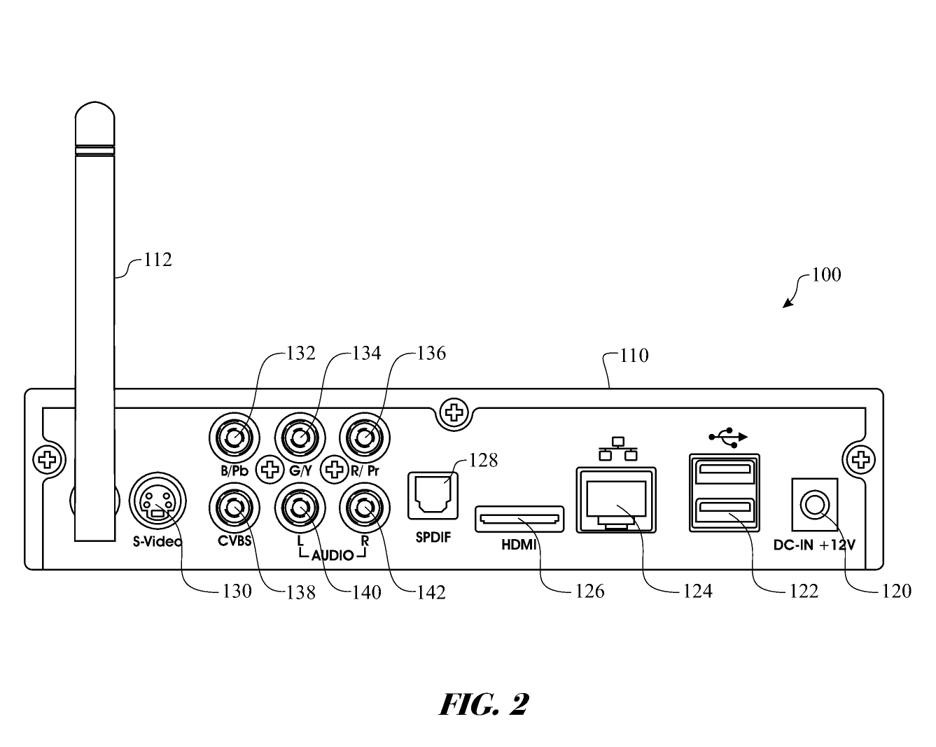

The primary components of the present invention are presented in FIGS. 1-3. A controller interface unit 100 includes circuitry, a microprocessor, respective software, and a host of audio-video interface formats and server access interface formats assembled within a controller interface housing 110. The controller interface unit 100 includes an electronic identification, which is communicated to system for validation. A status indicator is provided to communicate the status of the controller interface unit 100 to the viewer. Illustrated are a series of colored LEDs, utilized as follows: a power indicator 116, an Internet status indicator 117 and a server status indicator 118. The controller interface unit 100 is in signal communication with an audio-video device 150 via an audio-video signal interface 114. The audio-video signal interface 114 can be of any known format, including conventional formats for: (a) an s-video connector 130; (b) a blue 132/yellow 134/red 136 video signal connector; (c) a composite video baseband signal connector 138; (d) a left audio connector 140 and (e) a right audio connector 142. Alternatively, a high-definition multimedia interface connector 126 or SONY/PHILLIPS type digital interconnect format connector 128 can be utilized. The controller interface unit 100 can utilize any reasonable format for communicating between the controller interface unit 100 and a video distribution center. Exemplary communication formats include a wireless interface 112, a universal serial bus connector 122, and an Ethernet connector 124. A power connector 120 can be integrated to provide power from a wall outlet to the controller interface unit 100. The audio-video device 150 is fabricated having a display 154 assembled within an audio-video device housing 152. A series of speakers (not illustrated, but well understood in the art) can be integrated within the audio video device housing 152. A remote control 170 can be included, providing a means for the viewer to interact with the controller interface unit 100. The controller interface unit 100 can include an infrared (IR), radio frequency (RF), and any other receiver type for receiving directives from a variety of remote controls 170.

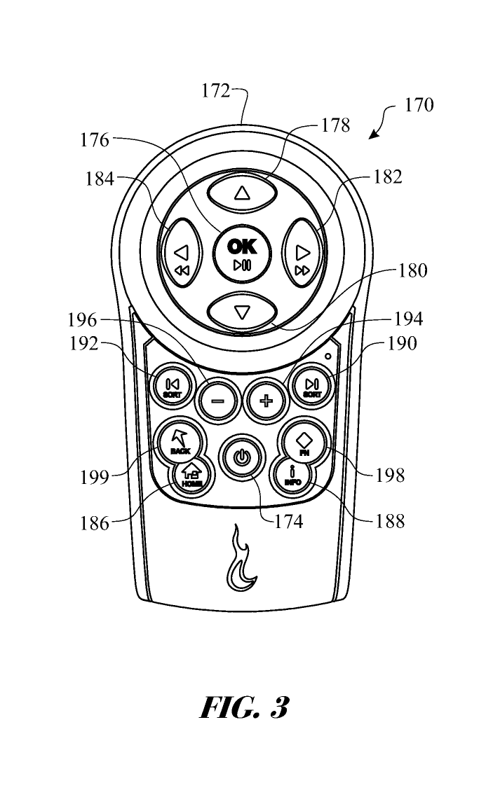

An exemplary custom remote control 170, shown in FIG. 3, includes a remote housing 172 having basic operative controls, including a power button 174, a select entry button 176, and directional controls such as an Up control button 178, a Down control button 180, Forward/Fast-Forward button 182, and a Rewind Fast-Rewind button 184. Additional controls, such as a Home Request button 186, an Information button 188, a Forward Sort button 190, Reverse Sort button 192, an Increase button 194, a Decrease button 196, a Function button 198, and a Back button 199 can optionally be included. The functionality of each of the controls is well understood in the relevant industry.

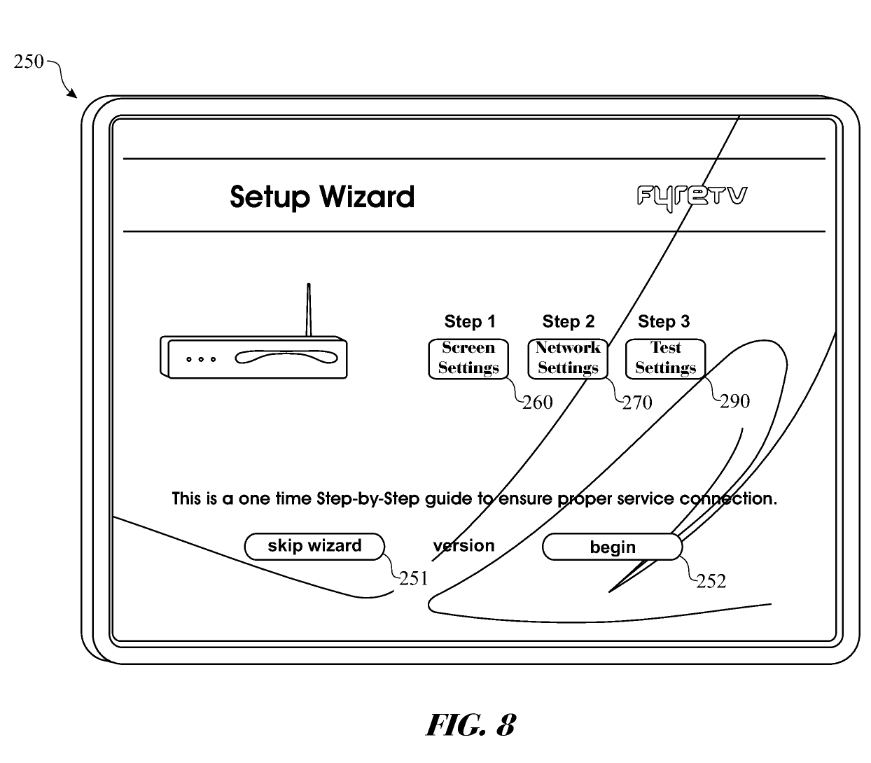

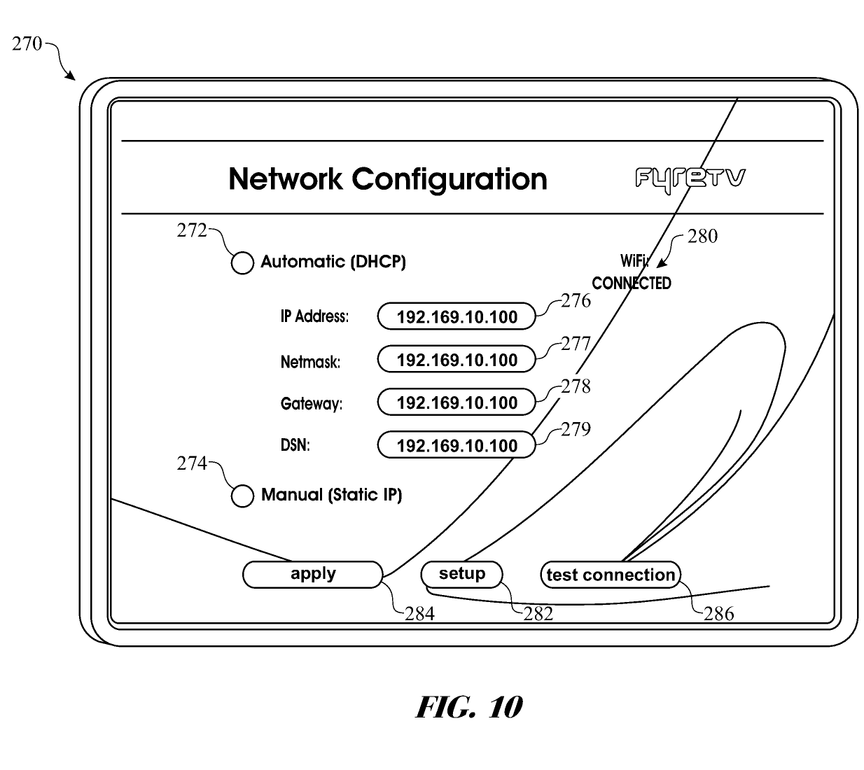

End user viewer interface with the system commences with a personal identification number (PIN) security access screen 160, preventing unauthorized access, such as by minors, to the system. Where the remote control 170 includes numbers, the viewer can simply enter the appropriate series of numbers to access the system. Using the exemplary remote, the viewer indexes each digit of a security access character input 162 via a character forward index 164, using the up arrow control button 178, and a character reverse index 166, using the down arrow control button 180. When the correct code is entered, the viewer selects the Select Entry button 176 or the Forward/Fast-forward button 182. To correct an inaccurate entry, the viewer can use the Rewind/Fast-Rewind button 184 to return to the respective security access character input 162. Since network connectivity may be required to verify the PIN, the viewer can select the Function button 198 to access the network settings set-up screen, such as setup wizard screen 250 (shown in FIG. 8) or network settings step 270 (shown in FIG. 10).

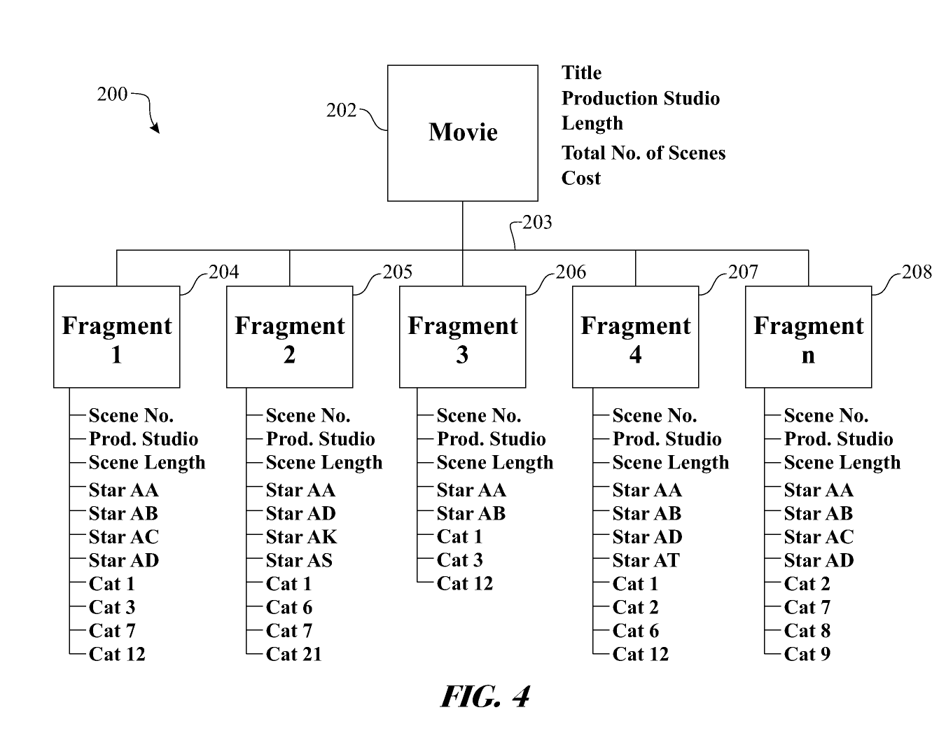

Content is configured and stored at the distribution center as presented in movie segmentation block diagram 200 of FIG. 4. The system controls distribution of any audio-video recording, including cinematic movies, sporting event recordings, documentary films, television programs, adult entertainment videos, and the like. A complete audio-video recording or movie 202 is segmented into an audio-video recording or movie segment/fragment series 203, shown as “Fragment 1” 204; “Fragment 2” 205; “Fragment 3” 206; “Fragment 4” 207; and “Fragment n” 208. The system stores information relative to the movie 202 and the fragments 204, 205, 206, 207, 208 in an information table. Exemplary searchable identifiers stored respective to the movie 202 may include: Title, Production Studio, Video Length, Quantity of Scenes or Fragments, Viewing Purchase Cost, Video Release Date, Starring Actors, and Video Rating, to name just a few. Exemplary information stored respective to each of the fragments 204, 205, 206, 207, 208 may include: Scene Number, Production Studio, Fragment Length, Starring Actors, Categories, Rating, and the like. Preferably, each of the stored elements is a searchable identifier. In an exemplary implementation of the system in connection with adult entertainment videos, categories of searchable identifiers can include: actor physical characteristics and attributes; ethnicity; background; sexual acts and positions shown; sexual genre; and type of sexual grouping (male-female, female-female, male-male, and group), for example. The system establishes a search index file comprising a plurality of predetermined video reference and content information categories and storing said search index file on at least one of an index server and a database server, wherein the video content information categories correspond to category data that are identifiable for each of said plurality of audio-video fragments.

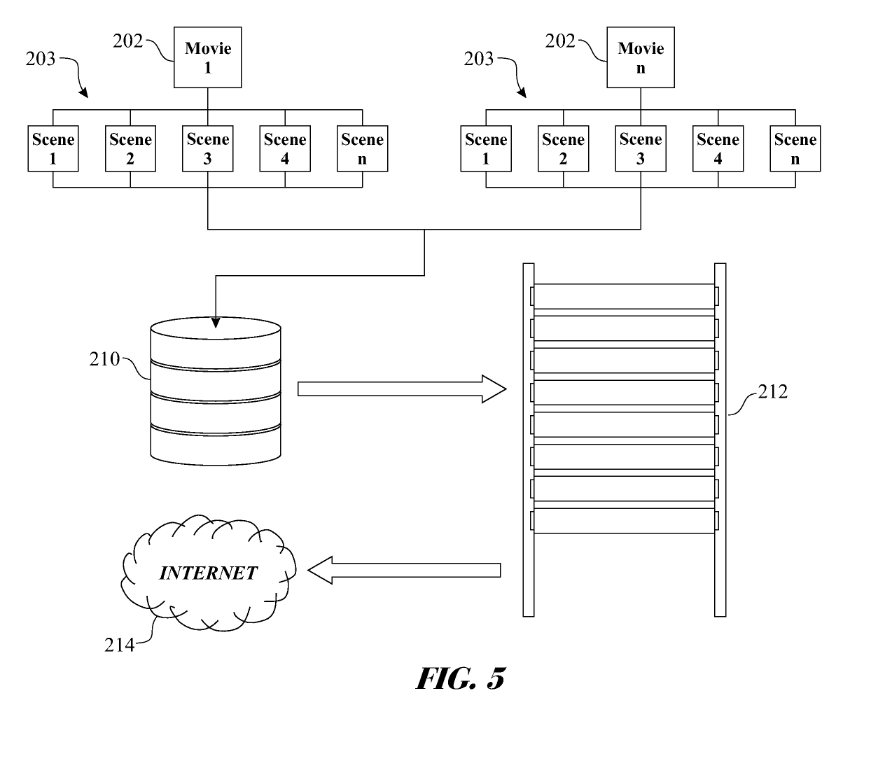

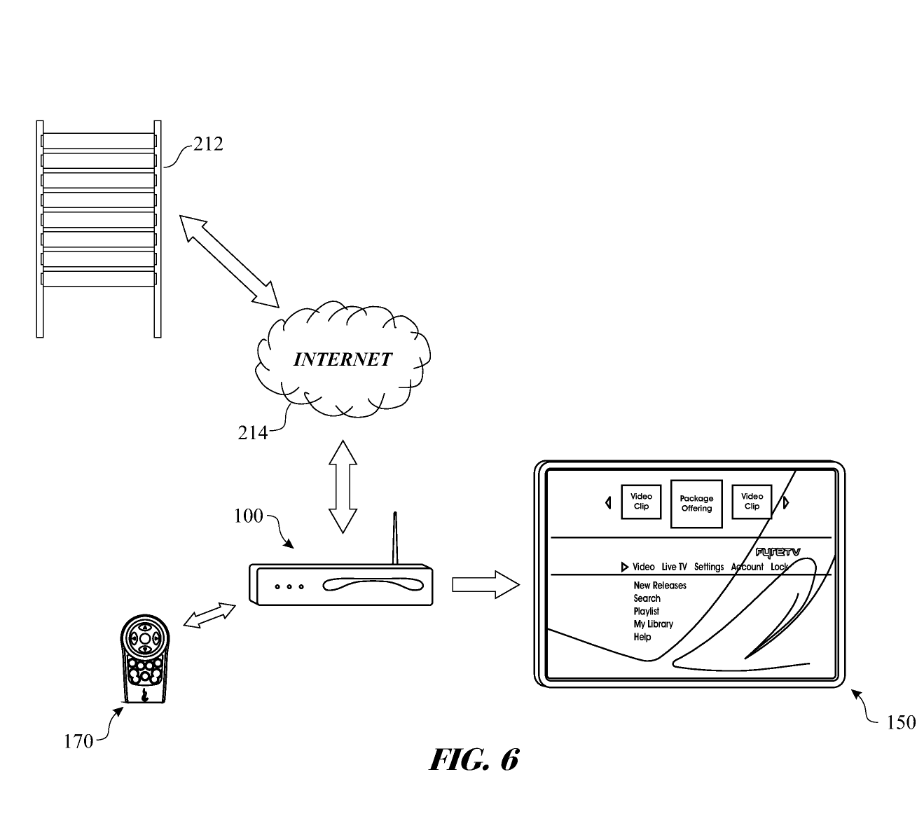

The information is stored on one or more database servers 210, as shown in FIG. 5. The database server 210 may be in data communication with at least one Internet server 212. The Internet server 212 provides a conduit for communicating with the controller interface unit 100 via an Internet 214 as illustrated in FIG. 6. The viewer enters and submits video or video fragment view requests using the remote control 170 (or other user interface) to direct the controller interface unit 100. The Internet server 212 interprets the request, obtains data from the database server 210, and transfers the data to the controller interface unit 100. The controller interface unit 100, in turn, presents the data in audio-video format to the viewer via the audio video device 150.

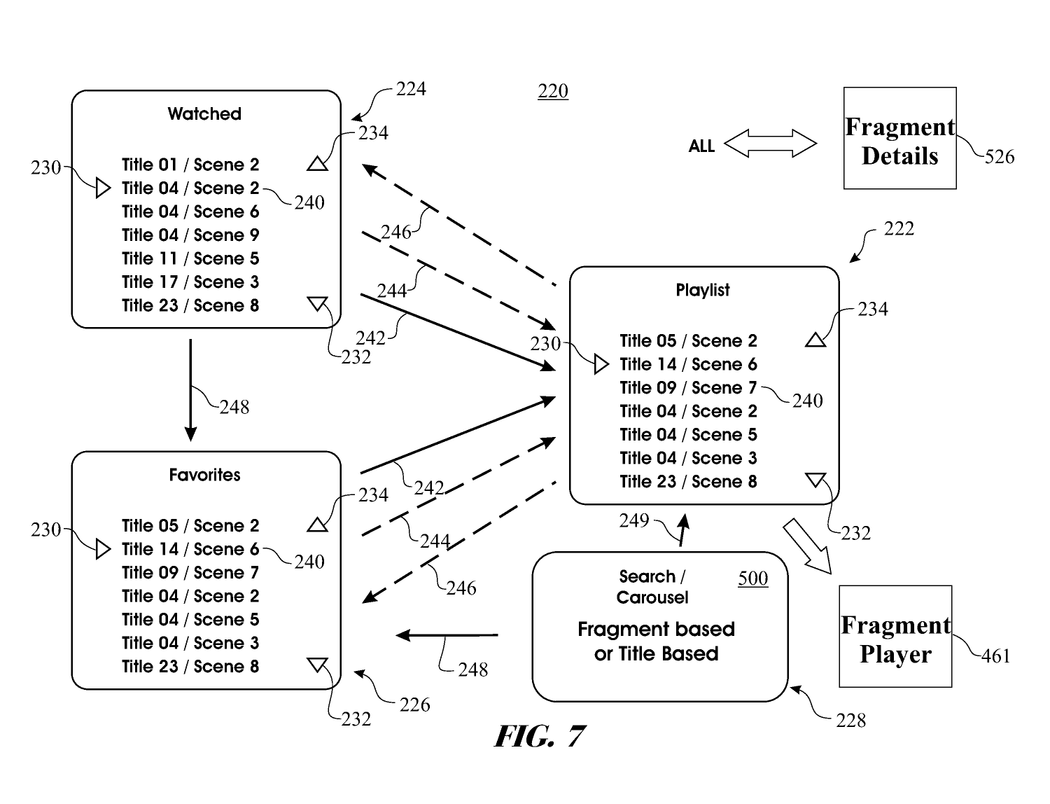

The user can create a plurality of list types, such as a Playlist 222, a Watched list 224, and a Favorites list 226. The interaction between the various playlists 222, 224, 226 is illustrated in a playlist block diagram 220 of FIG. 7. The playlists can also include a Library playlist for storing a listing of the entire user's purchased videos. The user can search the respective playlist by scrolling through the list. A title indicator 230 indicates the currently selectable title and scene reference 240. Should the list extend beyond the boundaries of the viewing window, scroll forward 232 and scroll reverse 234 commands can be used to scroll the through the listing. Each of the playlists 222, 224, 226 allows the user to add or delete a title and scene reference 240. The system allows the user to copy the title and scene references 240 from the Watched list 224 or Favorites list 226 to the Playlist 222 via a Copy Complete List command 242 or a Copy Individual Listing command 244. The viewer can save individual listings 246 from the playlist 222 as well. The viewer can alternatively view a series of video image 500 via a unique carousel format search 228. The viewer can add the title and scene reference 240 respective to the video image 500 to the playlist 222 via an “add to playlist” command 249. Once a video has been viewed, the title and scene references 240 are automatically added to the Watched list 224. The viewer can optionally add the title and scene reference 240 from the Watched list 224 or carousel search 228 to the Favorites list 226 via an “add to favorites” listing command 248. Additionally, the user can purchase any of the title and scene references 240, adding the title and scene reference 240 to the viewer's library (not shown). The viewer plays and views title and scene references 240 from the playlist within a player window 461. Information pertaining to the video fragment can be displayed in a video fragment information 526 window.

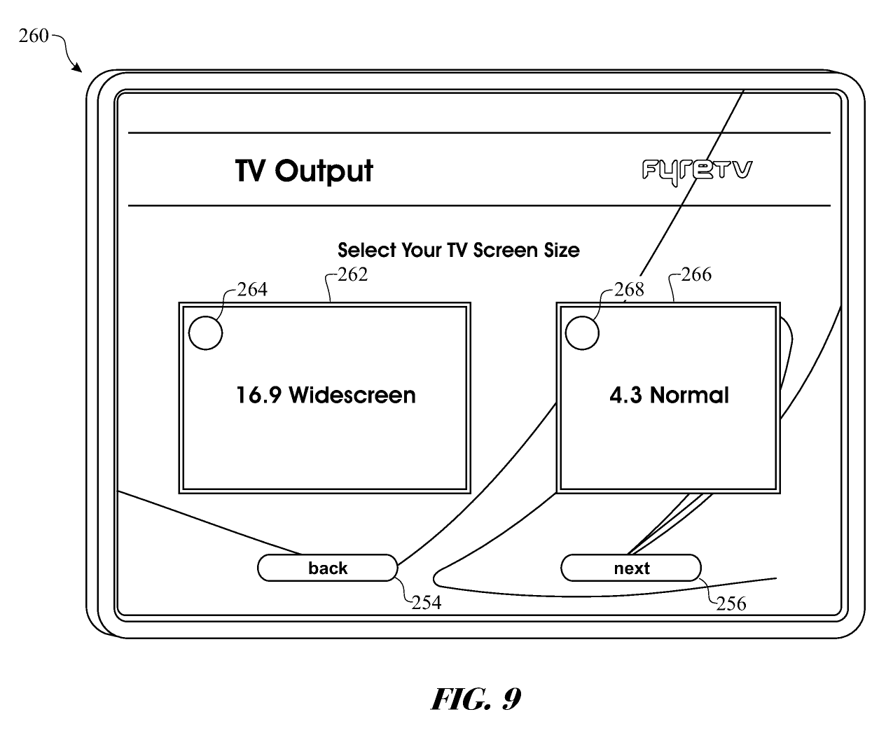

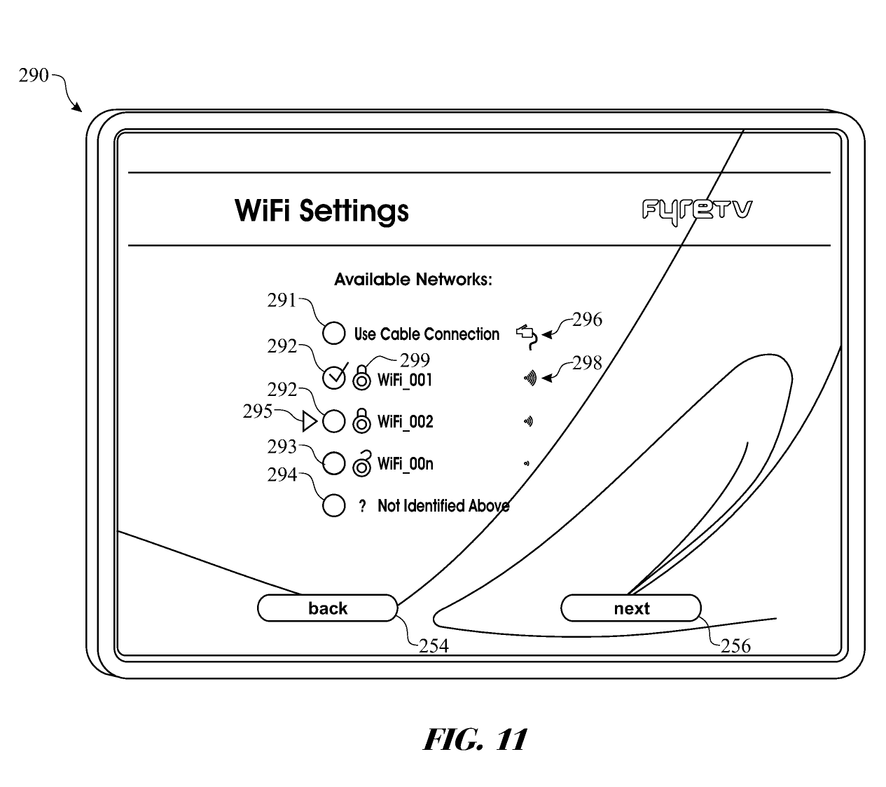

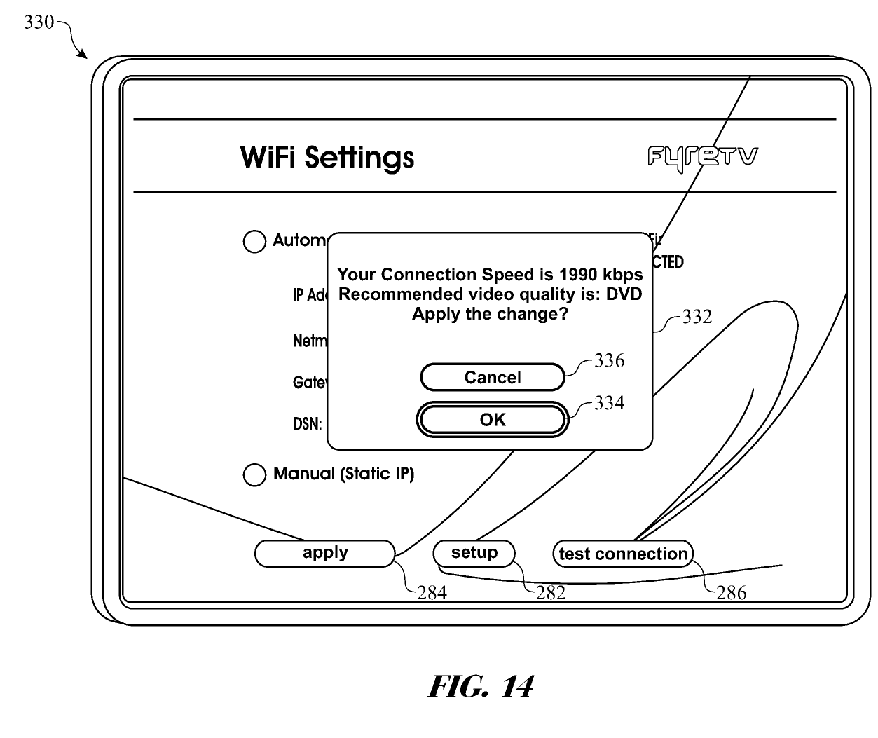

The user can manually configure the system, or the user can utilize a setup wizard screen 250 to configure the system using an automated process as shown in FIGS. 8-14. The automated process is presented in three exemplary steps: (1) a screen settings step 260; (2) a network settings step 270; and (3) a WiFi status 280. The setup wizard screen 250 provides the user with two options: (1) a Skip Wizard button 251, allowing the user to optionally skip the automated set up process; and (2) a Begin button 252, for initiating the automated set up process. Once initiated, the automated set up process proceeds to the screen settings step 260 and determines whether the system is utilizing a high definition format. If, in step 260, it is determined that the system is utilizing a high definition format, the system assumes that the monitor/display is a widescreen format (i.e., it defaults to widescreen format). The user selects either a widescreen 262 or a standard screen 266 by highlighting/selecting a Widescreen selection icon 264 or a Standard screen icon 268. Once proper screen format has been identified, the user selects a Next button 256 to proceed with the next step. Should the user desire to exit the process, she can simply select a Back button 254 to return to the setup wizard screen 250 and select the Skip Wizard button 251. The automated set up process continues to the network settings step 270. The user can direct the system to an automatic detection selection 272 or a manual entry selection 274. Should the user desire the manual entry selection 274, the user manually enters one or more of the following: (1) internet protocol (IP) address data 276; (2) net mask address data 277; (3) gateway address data 278; and (4) the domain name server (DNS) address data 279. Upon completion of any manual entry, the viewer can select an Apply button 284 to upload the information. When the user selects the Automatic Detection Selection 272, the system identifies the available IP address. The user can select a Setup button 282 to progress through an automated configuration process, as illustrated in FIGS. 11-14. A network identification step 290 presents the available networks. During the network identification step 290, a determination is made as to whether the network is: (1) a wired network, for example as through a wired connection 291, via a wired indicator 296; (2) a wireless network, such as a secured wireless connection 292, via a Wireless Signal Strength indicator 298; or (3) an unknown connection 294. The viewer can utilize the user interface, such as the remote control 170, to select the desired network. The system identifies the specific network being configured by the user interface via a connection selector 295. In the illustration, the user selected the WiFi_{—}001 network, which is secured as indicated by a secured network status 299 (shown as locked). Alternatively, the secured network status 299 can indicate a network is unsecured 293 when shown as unlocked. Once the user selects the desired network, the user selects the Next button 256 to proceed. The user can opt to select a Back button 254 to return to the previous screen.

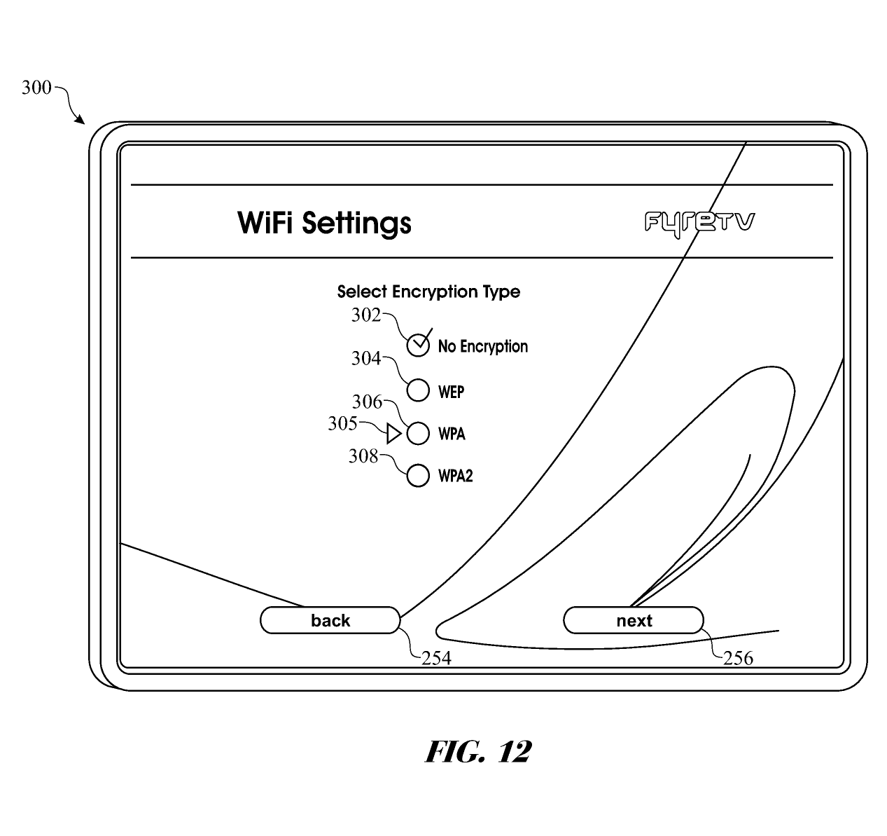

Once the network is selected, the process advances to an encryption selection step 300 as illustrated in FIG. 12. The user selects the associated encryption protocol from the listed options. The exemplary illustration presents a no encryption 302, a WEP encryption 304, a WPA encryption 306, and a WPAS encryption 308. It is understood that any encryption protocol can be included in the list, as well as allowing the user to enter a protocol that is not listed. The user would scroll between the listed encryption protocols using an encryption selection indicator 305. Upon indicating the desired encryption protocol, the user would indicate the same. Once the user selects the desired encryption protocol, the user selects the Next button 256 to proceed. The user can opt to select a Back button 254 to return to the previous screen.

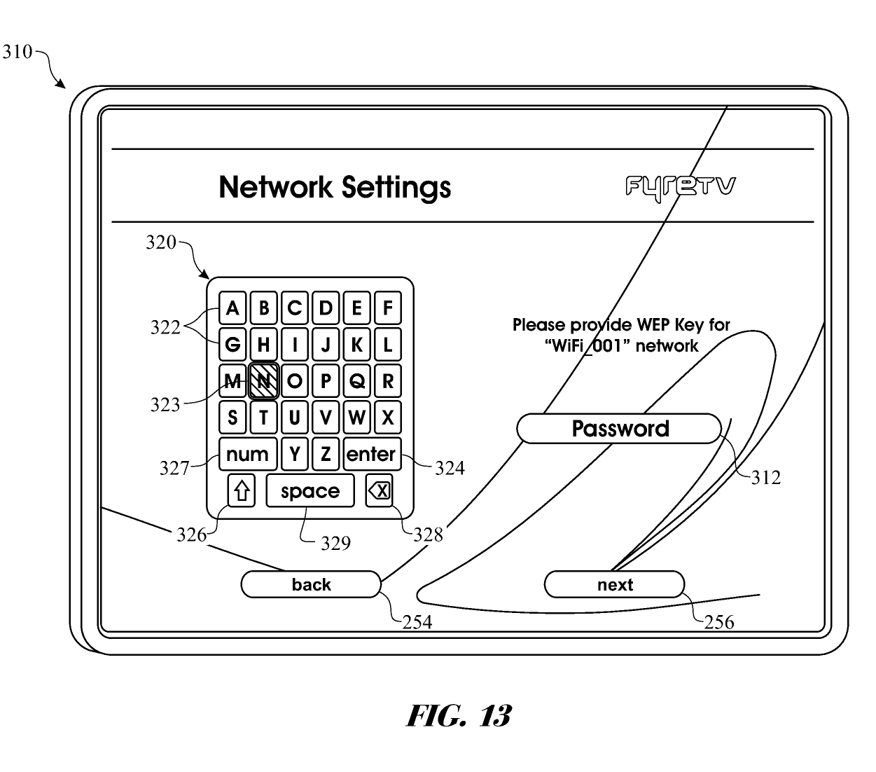

Once the encryption protocol is selected, the process advances to a password entry step 310 as illustrated in FIG. 13. The viewer enters a password using a character entry table 320. The character entry table 320 comprises a grid having a plurality of characters 322, preferably providing a complete alphanumeric character set. The letters can be separate from the numbers via a character set toggle such as an alphanumeric exchange selector 327. The user highlights a selected character 323 and hits the select entry button 176 (or similar) of the remote control 170 to select and submit the character to a password entry 312. The character entry table 320 can include additional keys such as an enter button 324, a shift key 326, a backspace button 328, and a space 329. It is also understood the character entry table 320 can include non-alphanumeric characters. The user would enter the series of characters to replicate the access password or pass-code. Once the password or pass-code is completely entered, the user selects a next button 256 to proceed. The user can opt to select a back button 254 to return to the previous screen.

The system includes a feature that automatically determines the optimal connection speed. The user selects the test connection button 286 of the network settings step 270 to run a test connection step 330. The system presents the recommended speed in a connection speed output 332 and provides two options for the user: (1) an Accept Speed setting selection 334 and a Reject Speed setting selection 336. The user can select either. The set up routine would be considered complete upon acceptance of the desired communication speed.

The system operation is arranged between search routines and configuring playlists, resulting in an optimized viewing experience. A main menu 400 is provided as a primary directory to the system. In the exemplary illustration, the main menu 400 can include selection headings 402 and a previewing window 460. The selection headings 402 comprise a series of directories, each directory comprising a unique listing of subcategories. The user can scroll the selection headings 402 to change the selected directory by positioning the selection indicator 404 to the selection headings 402 section, and entering the associated entry of the user interface, such as the Forward/Fast-Forward button 182 and Rewind Fast-Rewind button 184 of the remote control 170. The previewing window 460 presents a series of package offering previews 462 and/or fragment clip previews 464 in a carousel format. The user can advance or rewind the carousel of cover images using either a Carousel Forward 466 or a Carousel Rewind 468 command. The user can directly select one of the cover images to view the respective package, video or video fragment.

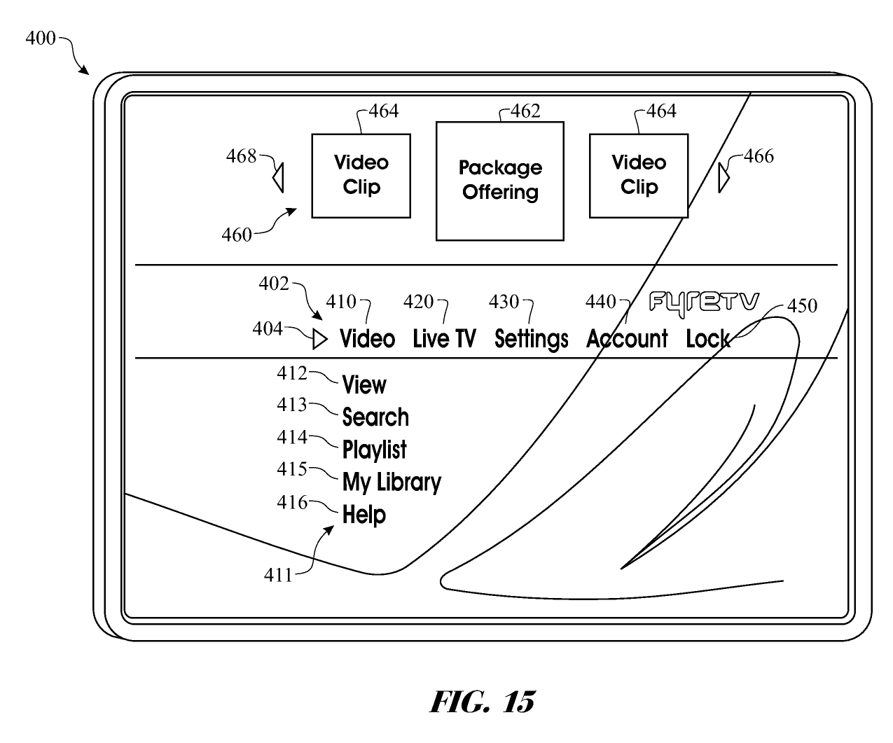

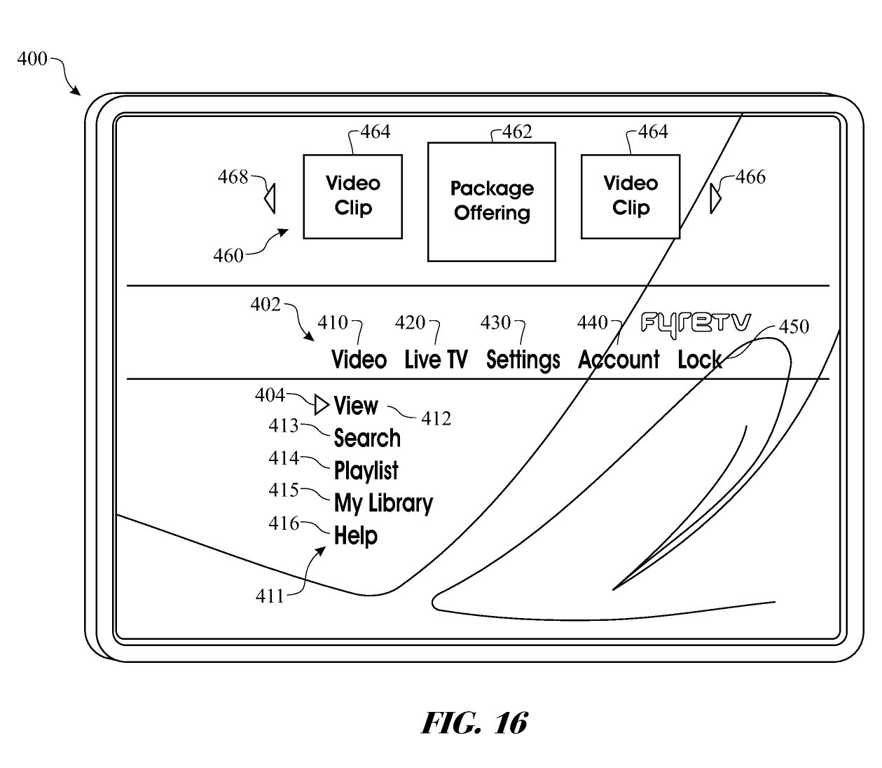

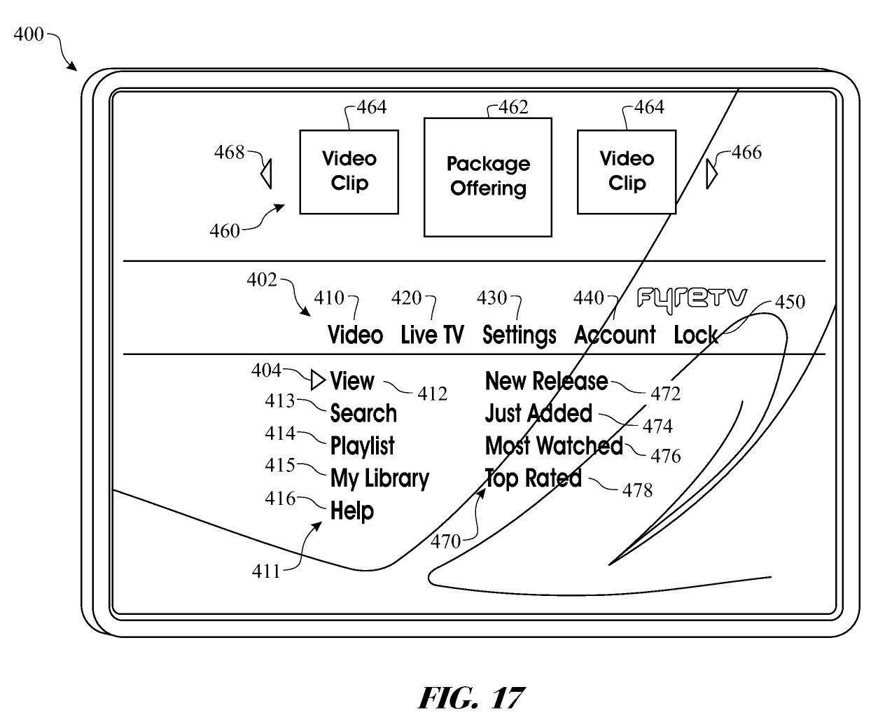

In the exemplary illustrations of FIGS. 15-18, the images present a series of selections. The selection headings 402 provide a series of directories for the user, including a Video directory 410, a Live TV directory 420, a Settings directory 430, an Account directory 440, and a Lock directory 450. In the representative illustration, the user initially selects the Video directory 410. The Video directory 410 is associated with a video subdirectory listing 411 comprising a View Subdirectory 412, a Search Subdirectory 413, a Playlist Subdirectory 414, a My Library subdirectory 415, and a Help link 416. The viewer utilizes the selection indicator 404 to identify and select a subdirectory. The View subdirectory 412 is shown as being selected in FIG. 16. The system subsequently presents View subdirectory options listings 470, including New Release 472, a Just Added 474, Most Watched 476, and Top Rated 478. The user can select any of the listings from the View subdirectory options listings 470 and the system will present the respective videos and/or video fragments in any reasonable scannable format. The help link 416 (provided throughout many of the subdirectory listings) offers the user a link to a help screen. The help screen demonstrates the specific feature or features base upon which subdirectory the help link was selected.

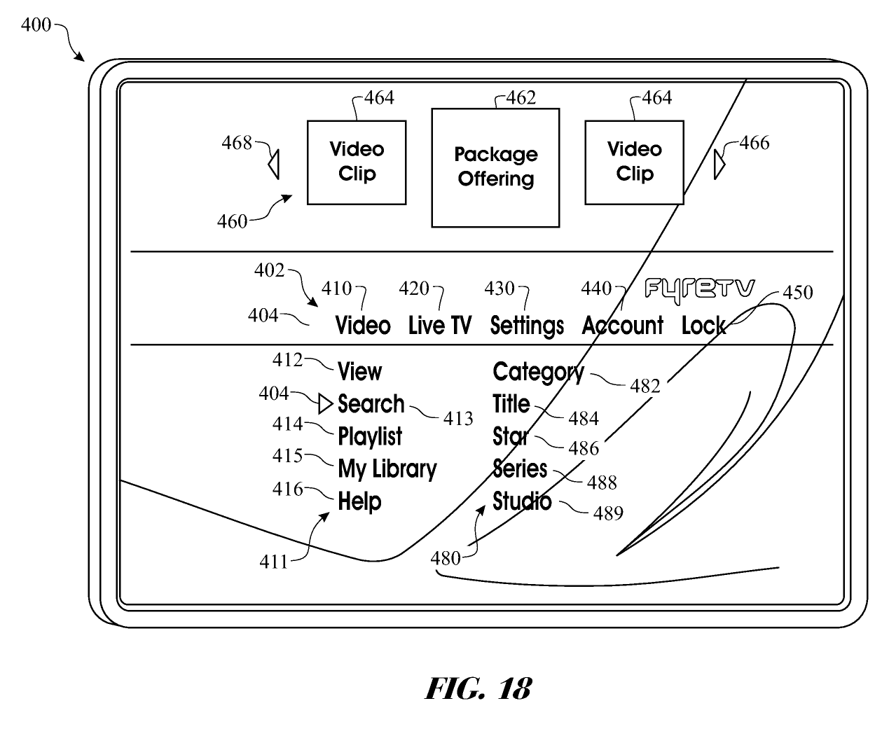

The viewer can optionally select the Search subdirectory 413 as shown in FIG. 18. The system subsequently presents a Search options listings 480 comprising an Identifier search 482, a Title search 484, a Star search 486, a Series search 488, and a Studio search 489. The Identifier search 482 may be referred to as an identifier or a category, and provides a means for identifying a specific feature of a star, a specific action portrayed within the video or video fragment, location, weather, event, and the like. In the exemplary implementation, the Identifier search 482 includes a series of identifiers relating to the adult entertainment industry, such as, for example, race, hair color, breast size, actor sex, type of sex act, and the like. As previously stated, the implementation of the system with regard to Adult Entertainment is merely exemplary. For example, the system and method could be beneficially implemented for use in connection with sporting even video entertainment, including, but not limited to: (1) ball game sporting events, to view preferred video snippets of player highlights, game endings, overtime periods, fights, controversial referee decisions, outstanding plays, etc.); (2) vehicle racing (driver highlights, accidents, finishes); and (3) boxing and martial arts events (fighter highlights, knockouts, controversial punches, etc.) to name just a few.

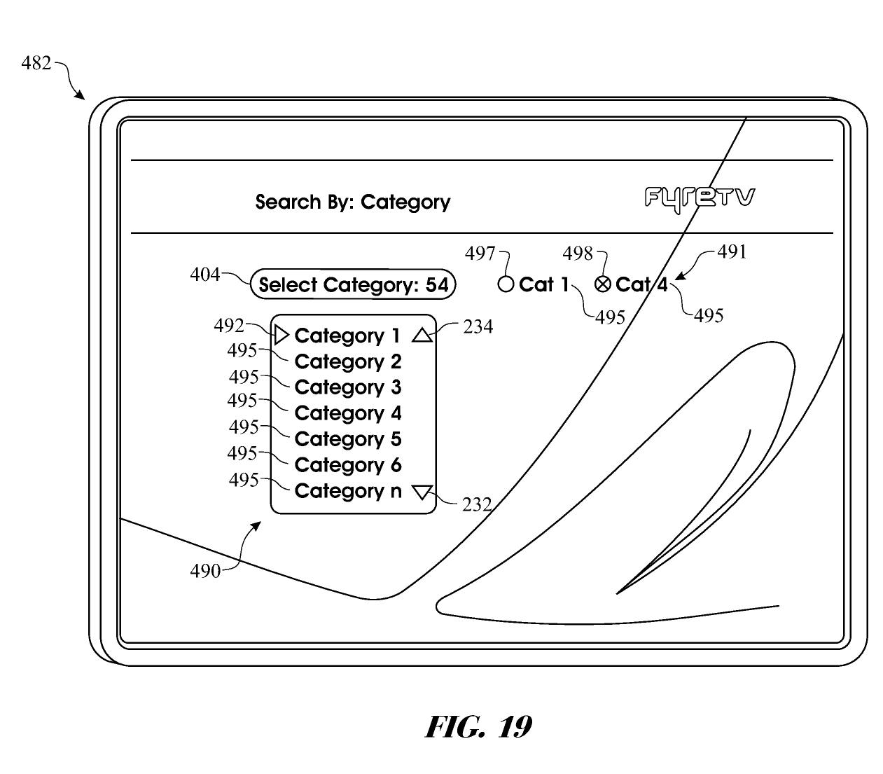

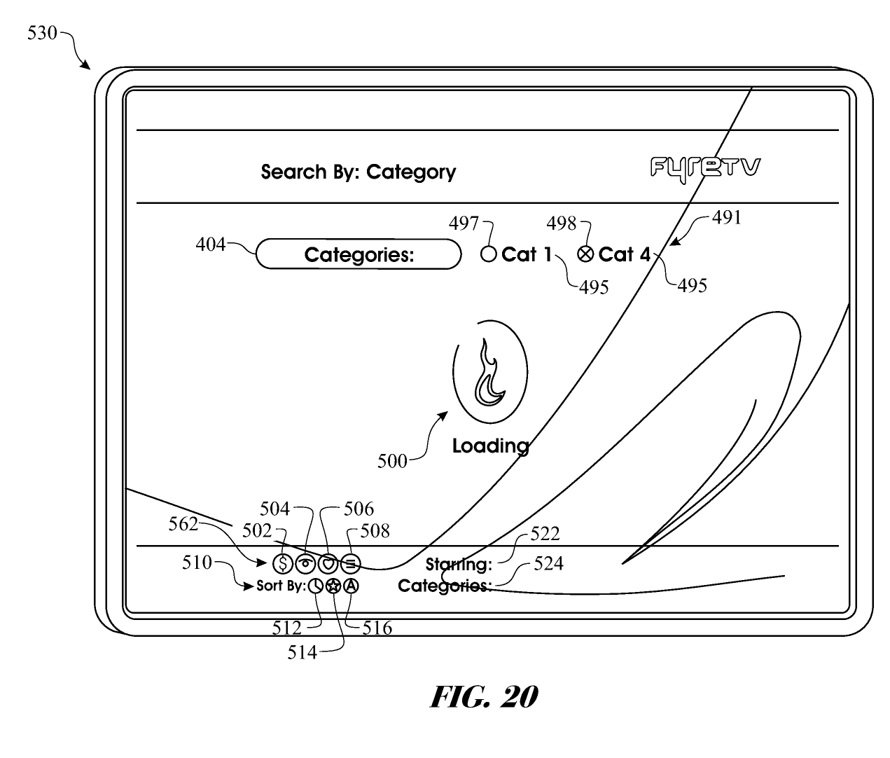

The Identifier search 482 can be presented in a variety of formats. A simple, scrolling category selection listing 490 may comprise a series of Identifiers 495 as presented in FIG. 19. The user scrolls through the category selection listing 490 using the Scroll Forward 232 and Scroll Reverse 234. The user aligns a Category indictor 492 with the desired Identifier 495. The user can select the Identifier 495 using an include entry selection, such as the Increase button 194 of the remote control 170, or an exclude entry selection, such as the Decrease button 196 of the remote control 170. An include entry can be indicated via an inclusion identifier 497 and an exclude entry can be indicated via an exclusion identifier 498. The illustration presents a selected category summary 491, wherein the selected category summary 491 summarizes of all selected identifiers, including both inclusion identifiers 497 and exclusion identifiers 498. The search would return all videos and/or video fragments, based on the inclusion identifiers 495 and excluded identifiers 495 as illustrated in fragment search results 530 in FIG. 20. The user can configure the fragment search results 530 to present the search results in any of a variety of sorted orders, including, for example, alphabetical 516, by Listing 510, by Release Date 512, and by Ratings 514. The user can select the desired search or place the search settings in a desired hierarchy. Additionally, the search results can present a listing of video specific stars 522 and a listing of video specific identifiers 524. The video or video segment 500 listings from the search results can be presented in any format, including linear, listing, and carousel, for example.

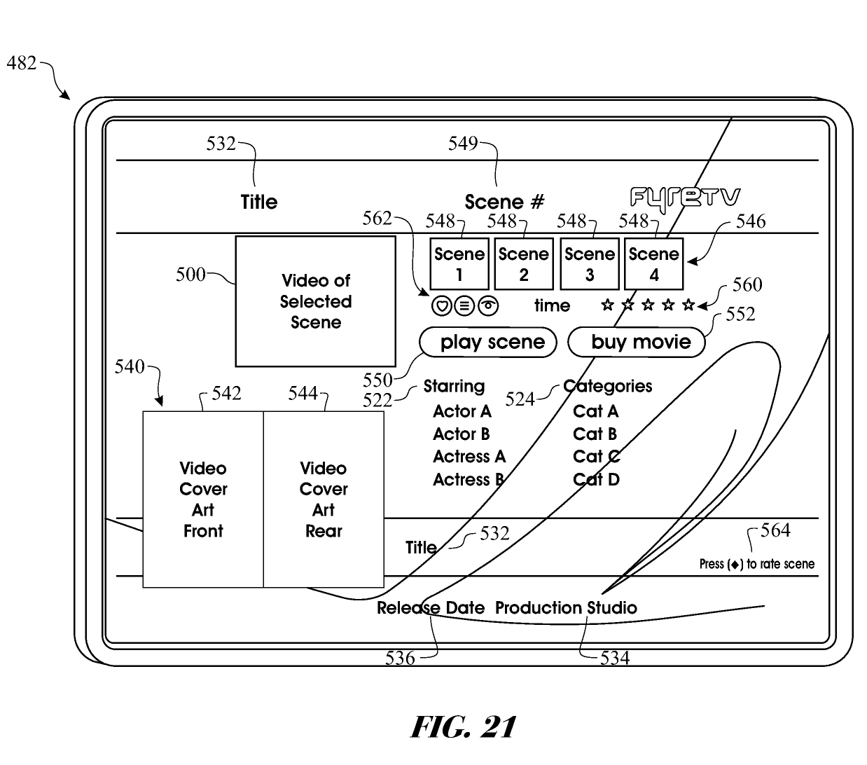

A second exemplary format of the identifier search 482 is presented in FIG. 21. The illustration presents a video fragment series 546 including a plurality of video fragment images 548 based upon a selected category summary 491. The selected category summary 491 presents a summary of all selected identifiers, including both included identifiers 497 and excluded identifiers 498. The user can scroll through the video fragment series 546 and select any desired video fragment images 548. Once selected, a video image 500 and information specific to the selected video fragment images 548 is presented to the viewer. The illustration presents several exemplary items of information, including the video title 532, the video cover art 540 (preferably both front cover art 542 and back cover art 544), the listing of video specific stars 522, the listing of video specific identifiers 524, the release date 536 the production studio 534, and the scene number 549. The viewer can select a Play Scene button 550 to watch the video image 500 or video fragment images 548, or select a Buy Movie button 552 to purchase the video image 500 or video fragment images 548. Additionally, user feedback information such as playlist indicators 562 and a rating 560 can be presented. The playlist indicators 562 can include icons indicating a watched video 504, favorite video 506, playlist video 508, and the like. In the preferred embodiment, the viewer can only rate video fragment images 548 while the viewer is viewing the respective video fragment images 548. A link to Rate Scene 564 is provided and activated while the viewer is watching the respective video fragment images 548. In the exemplary embodiment, the user would select the function button 198 of the remote control 170 to redirect the user to the rating selection 670.

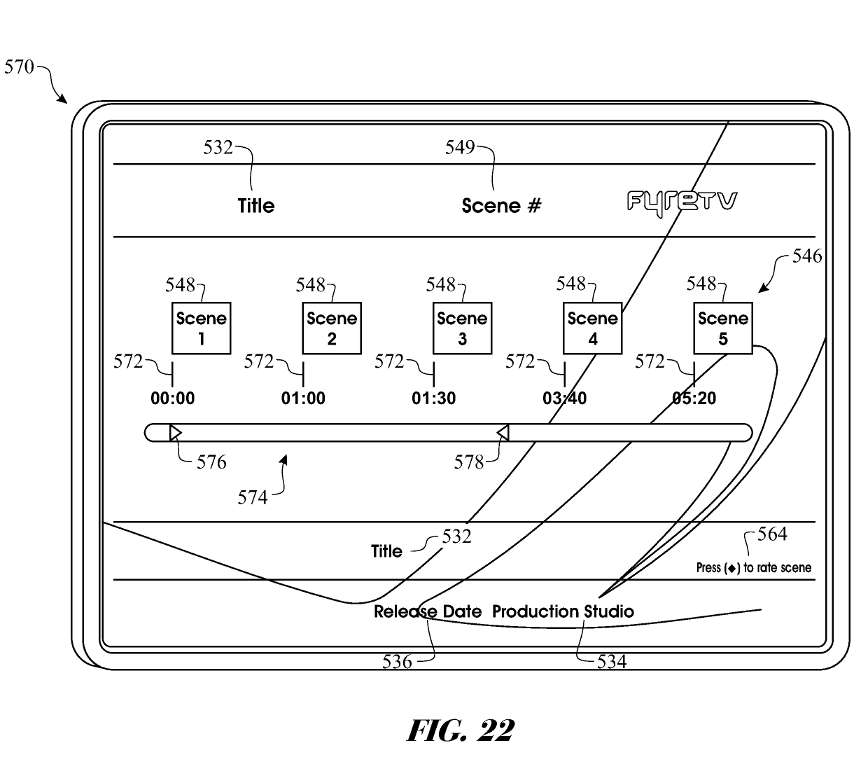

The user can view the video fragment series 546 in a variety of formats. A sequential video fragment viewing screen 570 is presented in FIG. 22. The video fragment series 546 provides a series of video fragment images 548, including a respective series of scene fragment time markers 572. A user time marker bar 574 is provided, enabling the user to select a Start marker 576 and a Stop marker 578, to create a user defined fragment from the video fragment series 546. The user can then store the information required to replay the new user defined fragment.

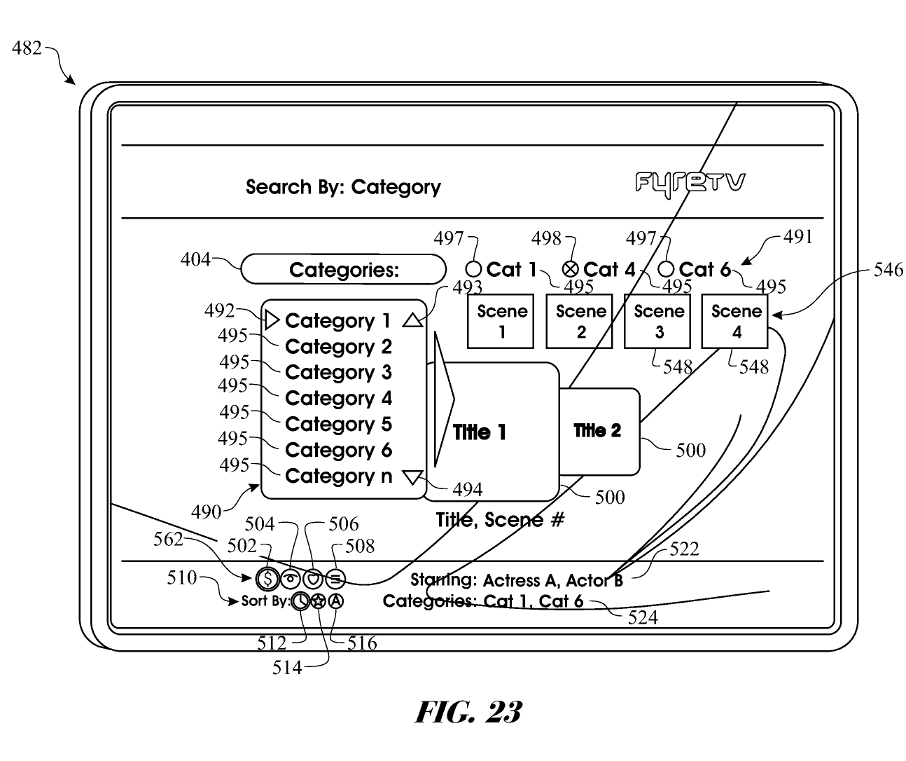

Referring now particularly to FIG. 23, in a third exemplary format of the identifier search 482 features similar to those presented in FIG. 21 are provided in a different layout. The Sort by Listing 510 and Playlist indicators 562 can be included if desired. The illustrated format presents both a series of video image 500 as well as a video fragment series 546.

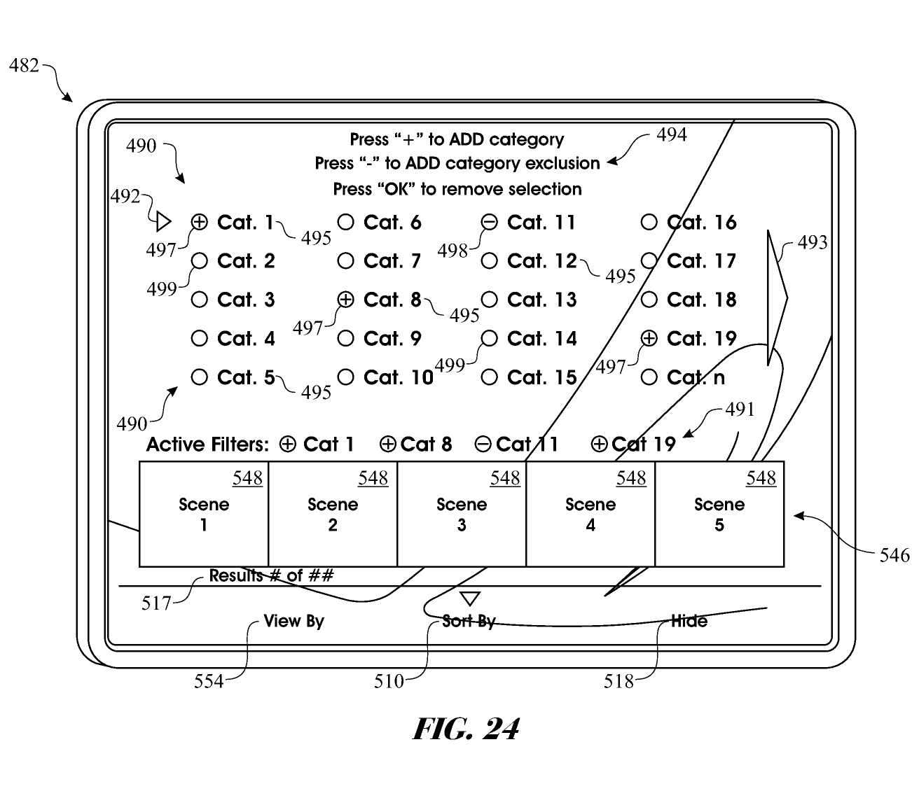

A forth exemplary format of the identifier search 482 is presented in FIG. 24, wherein features similar to those presented in FIGS. 19-21 are presented in a selectable array layout. The format presents a series of identifiers 495 in a grid, allowing the user to quickly identify the desired identifier 495 for selection. A Category Scroll 493 allows the user to scroll the grid for access to additional categories. It is understood that the category scroll 493 can scroll in both the forward (as shown) and reverse (not shown) directions. The viewer utilizes the category indictor 492 to identify the active identifier 495 for selection. The user can select the identifier 495 using an inclusion command such as via the Increase button 194 of the remote control 170, or an exclusion command, such as via the Decrease button 196 of the remote control 170. An inclusion entry can be indicated via an inclusive identifier 497, and an exclusion entry can be indicated via an exclusion identifier 498. Unselected identifiers 499 are not considered during the search. The selected identifiers 495 would be added and presented via the selected category summary 491. The video fragment images 548 meeting the search criteria would be presented in the video fragment series 546. A Total Results reference 517 can be included to provide the user with a reference for which video fragment images 548 are being viewed from the complete returned series 546 matching the search results. Several additional features are introduced in the illustration, such as a View By option 554, a Sort By listing 510, and a Hide option 518. The View By option 554 allows the user to change the format in which the video fragment images 548 are presented. The Sort By listing 510 allows the user to sort the returned series 546 matching the search results via any of a variety of search criteria, such as those previously described herein. The Hide option 518 allows the user to toggle the screen view between displaying/showing and hiding the sections of the screen, including the category selection listing 490 and the video fragment series 546.

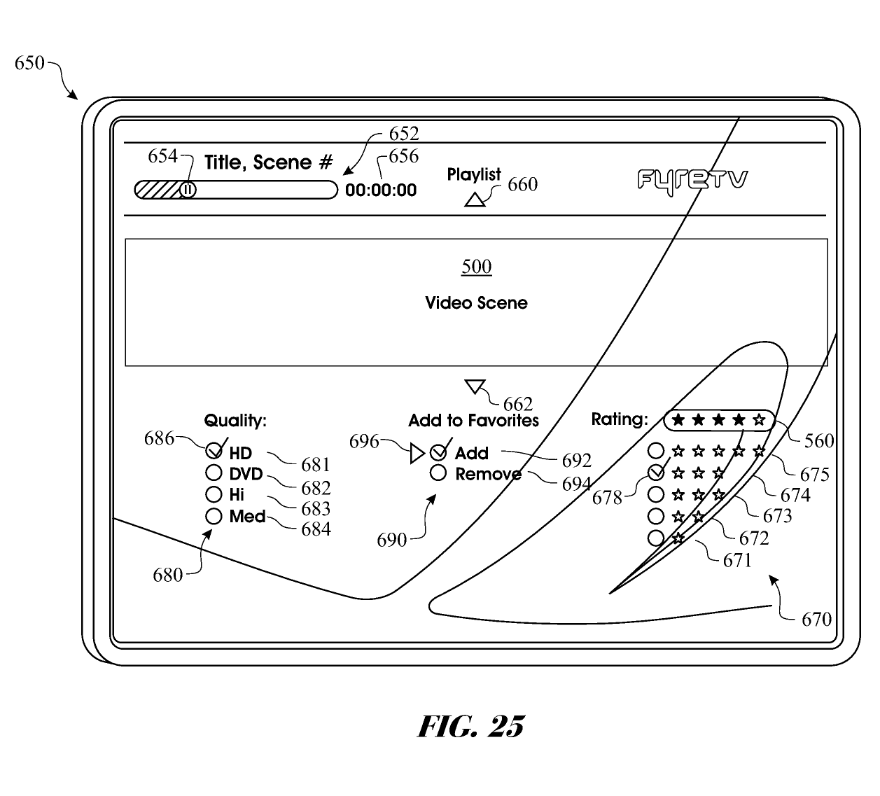

Referring now particularly to FIG. 25, a user video management display screen 650 enables the user to manage various information relating to the video image 500. The system presents a visual reference or graphic 654 to indicate the precise position of the current scene vis-à-vis the entire movie. A video portion viewed indicator bar 652 provides further visual indication of the portion of the video that has already been viewed. The indicator 652 can present the information in either graphical format, such as a video portion viewed graphic 654, a numerical format/status, such as a numeric time of video portion viewed 656, or both, as shown. User feedback controls, shown as several exemplary embodiments including a rating selection 670, a video quality options 680, and a favorites selection option 690, provide the user with the ability to interact with the system with respective to the specific video image 500. A cursor 696 presents the user with an indication of those features or lines with which the viewer is interacting. The rating selection 670 provides the user a facility to enter or modify their rating of the video image 500. The user selects a rating within a listed ratings range, shown as a one star rating 671, a two star rating 672, a three star rating 673, a four star rating 674, and a five star rating 675. In the exemplary illustration, the user has selected the four-star rating 674, as indicated via viewer selected rating 678. The video quality options 680 provide the user with a facility to adjust the preferred viewing quality of the video image 500. The user would select a quality within a quality range listing, shown as a high definition setting 681, a digital video display setting 682, a high resolution standard setting 683, and a medium standard resolution setting 684. In the exemplary illustration, the current setting is indicated via a video quality setting 688. The Favorites Selection option 690 allows the user to add, via an Add-To-Favorites option 692, or remove, via a Remove-From-Favorites option 694, the specific video image 500 from their Favorites playlist 586. The viewer can use an upper screen Hide toggle 660 and a lower screen Hide toggle 662 to toggle the viewable area, including viewing or hiding the video portion viewed indicator 652, and viewing or hiding the user feedback controls. This would also adjust the viewing size for viewing the video image 500 accordingly.

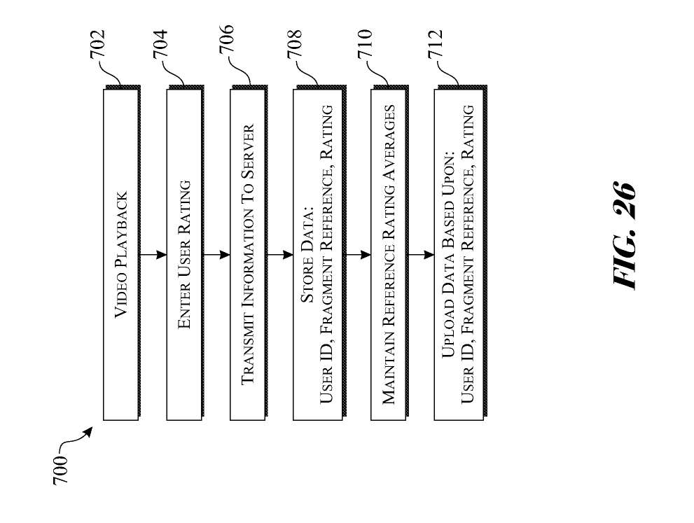

Referring now particularly to FIG. 26, ratings entry flow diagram 700 illustrates the rating selection 670 process. The ratings entry flow diagram 700 commences with the viewer watching, in step 702, the video 500. The user then selects a rating, in step 704. The viewer selected rating 678 is uploaded to the database server 210 in accordance with a communicate user rating to service provider 706. The uploaded information can include the rating selection 670, reference information for the video image 500, scene or fragment number, the viewer's information, the time and date, and any other pertinent information. This allows any ratings previously submitted by the viewer to be overwritten/replaced. The database server 210 stores the rating information in accordance with a service provider data storage step 708. The system then utilizes all of the submitted ratings associated with the package offering preview 462, fragment clip preview 464, and/or video image 500 to determine an average rating in accordance with a maintain submitted rating information step 710. The system can either store the average rating or calculate the average rating, as needed. Rating information can be returned, in step 712, to the viewer based upon the viewer's identification, a fragment reference, and the like. The rating can include the average rating of all viewers and/or the rating of the specific viewing party.

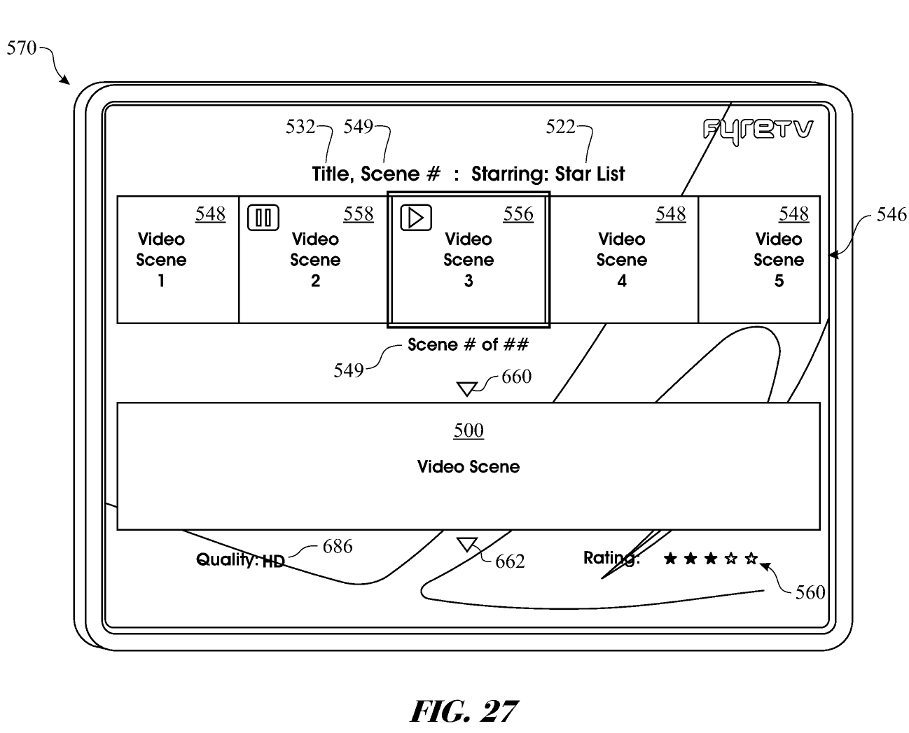

An alternative configuration of the sequential video fragment-viewing screen 570 is presented in FIG. 27. The illustrated exemplary format provides a video fragment series 546, introducing two features: (1) a Playing Video 556 and a Paused Video 558 feature. The user can select any of the visual video fragment images 548 of the video fragment series 546 to play the playing video 556. The viewer can scroll through the video fragment series 546 to access any desired video fragment images 548. The currently playing video 556 can also be viewed in a larger format as a video image 500. At any point during viewing, the user can place the video into a pause mode, as represented by the paused video symbol 558. The exemplary format additionally presents the video title 532, the scene number 549, the listing of video specific stars 522, the scene number 549, the current video quality setting 686, and the rating 560. The screen is segmented into three sections, which can be toggled between a visible and a hidden state via the upper screen hide toggle 660 and lower screen hide toggle 662.

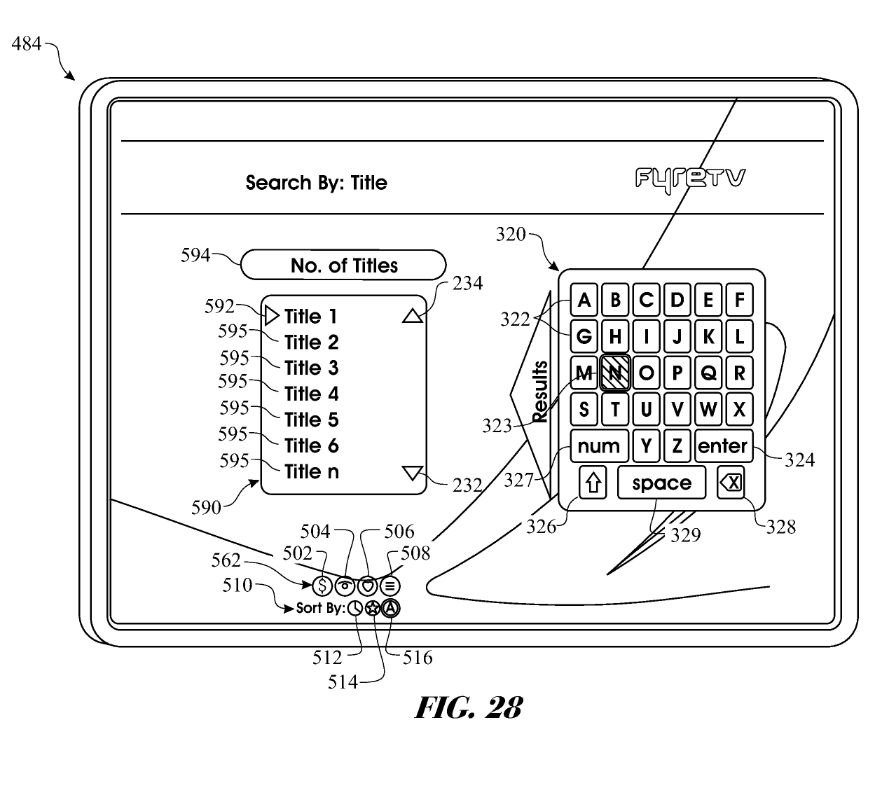

Additional search routines are also provided to the viewer, including a Title search 484, a Star search 486, a Series search 488, and a Studio search 489. An exemplary format of the Title search 484 is presented in FIG. 28. In each of the search routines, the viewer utilizes an entry method such as the character entry table 320, as previously described. The user enters the desired text for searching. The search routing searches for the string of characters of the text within any of the text of each of the categories. An information display can present any desired information such as the number of titles 594. In the Title Search 484, the user enters a string of characters to find a desired title 595. The Title search 484 presents the returned results in a Title Selection listing 590 in the format of a series of titles 595. The user can scroll through the Title Selection listing 590 via a Scroll Forward 232 and a Scroll Reverse 234. The user identifies the desired title 595 via a Title Indictor 592. The Title Search 484 can include sort by listing 510 and playlist indicators 562 to aid the user in searching for a desired title 595.

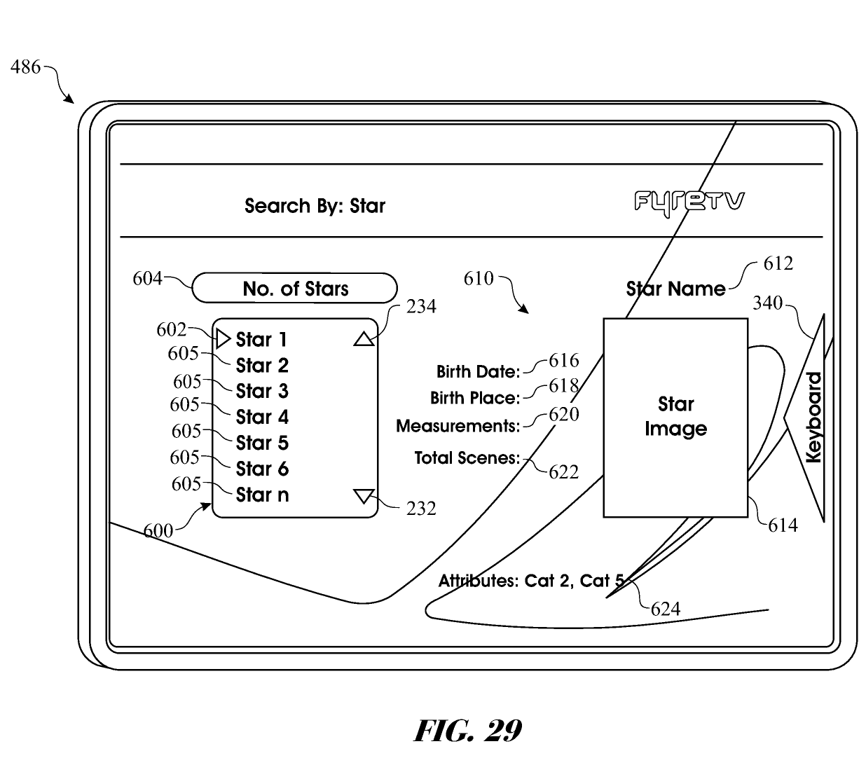

Referring now particularly to FIG. 29, a Star search 486 displays features similar to the Title search 484 shown in FIG. 28. In the exemplary format of FIG. 29, the Star search 486 process commences with the viewer entering a portion of the star's name via a keyboard (shown as hidden and viewable via a keyboard viewing toggle 340). As the user enters characters, the star search 486 continuously/dynamically returns a list of star names 605, falling within the current search criteria, within a star selection listing area 600. The process can display a numerical value 604 indicating the quantity of currently listed stars 605 listed. The user can scroll through the star selection listing 600 via the Scroll Forward 232 and the Scroll Reverse 234 options, using a Star Indictor 602 to identify the cursor location respective to the specified Star 605 for the viewer. With the character entry table 320 hidden (as illustrated), a star information screen 610 can be presented, displaying information about the selected star 605, such as the star's name 612, a photographic image of the star 614, and the like. Other star-related information, such as birth date 616, birthplace 618, physical measurements 620, quantity of scenes shot 622, and a listing of the star's attributes 624 may be displayed.

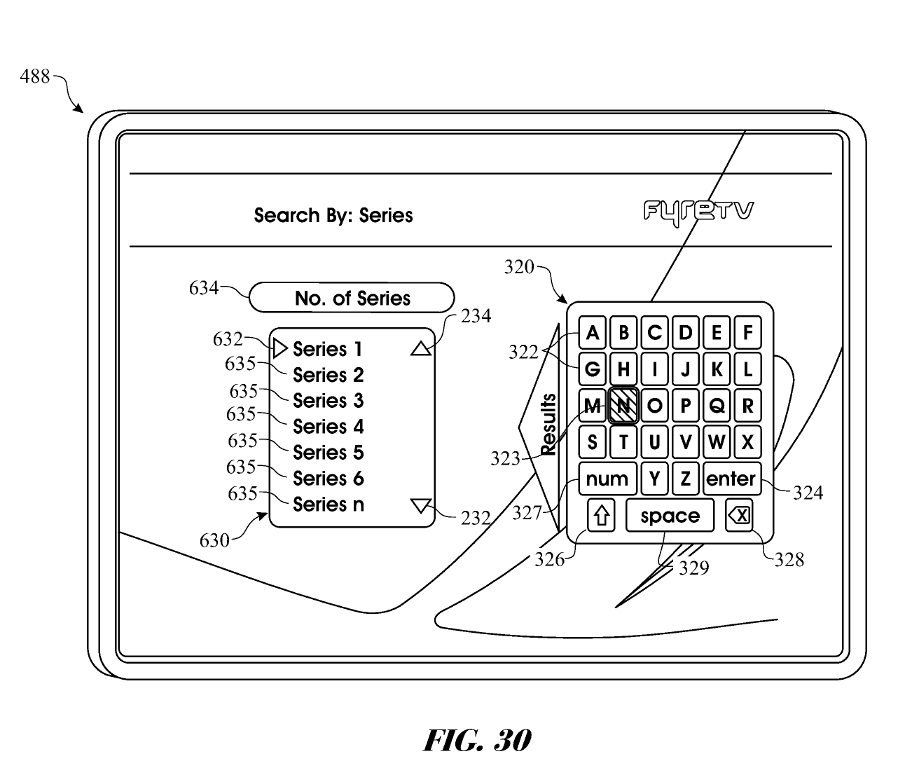

Referring now to FIG. 30, a Series search 488 can be provided in a format similar to that of the Title search 484 of FIG. 28. In the Series search 488, the user inputs a string of characters to find a desired series 635. The Series search 488 presents the returned results in a Series selection listing 630 containing a list of series'. The series quantity 634 can be presented informing the user of the quantity of returned search results. The user can scroll through the series selection listing 630 via a scroll forward 232 and a scroll reverse 234. The user identifies the desired series 635 via a series indictor 632. The user can toggle the view of the character entry table 320 to present additional details of the selected series 635.

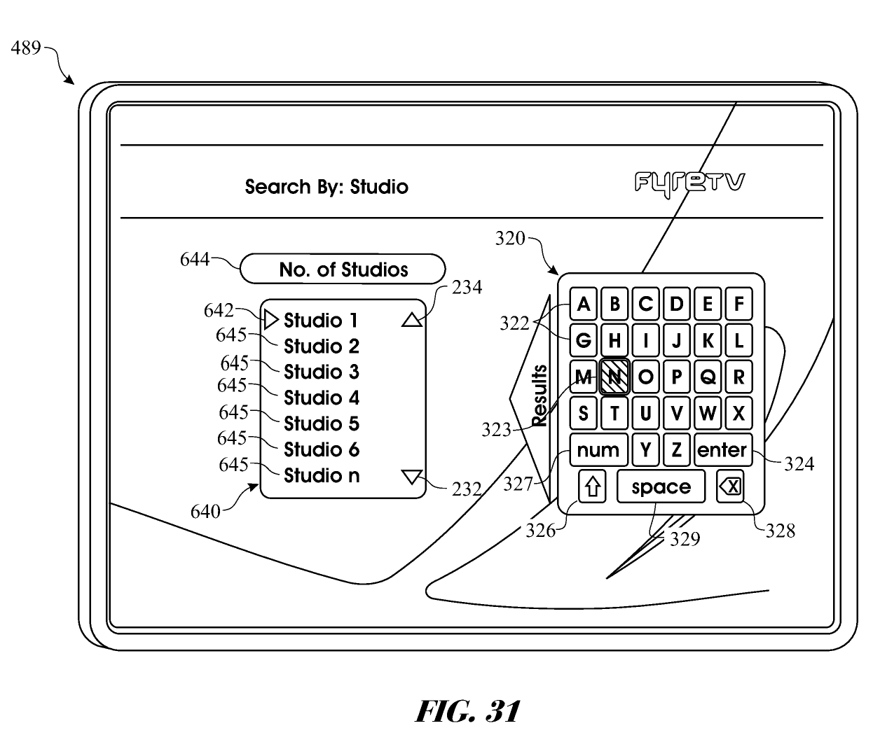

A Studio search 489 comprises features similar to the Title search 484 of FIG. 28. An exemplary format of the Studio search 489 is presented in FIG. 31. During the Studio search 489, the user enters a string of characters to find a desired studio 645. The Studio search process 489, the returned results in a Studio selection listing 640 in the format of a series of Studios 645. The total number of Studios 644 can be presented informing the user of the size of the returned search results. The user can scroll through the Studio selection listing 640 via a scroll forward 232 and a scroll reverse 234. The user identifies the desired Studio 645 via a Studio indictor 642. The user can toggle the view of the character entry table 320 to present additional details of the selected Studio 645.

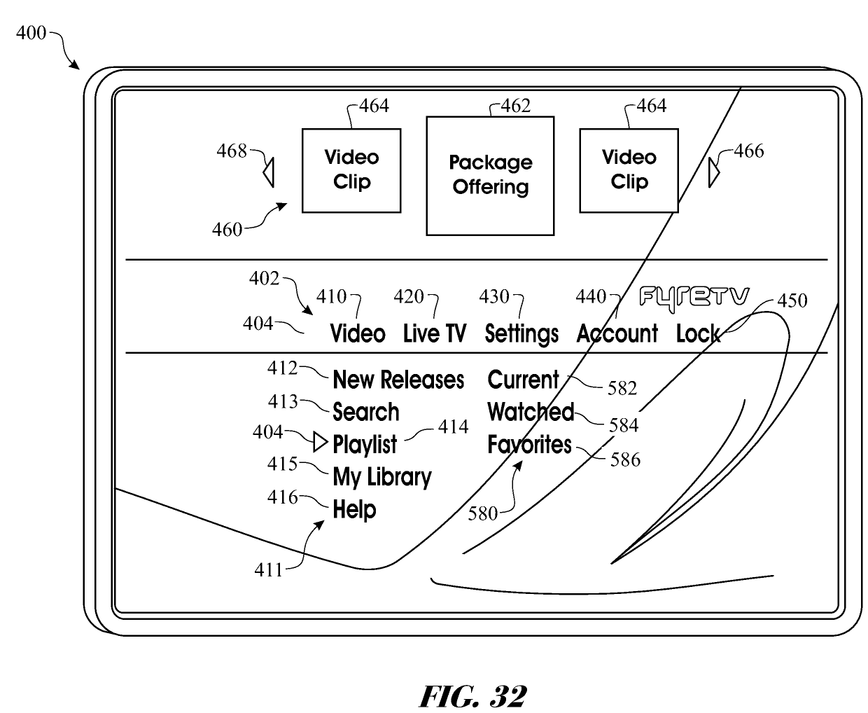

Continuing through the video subdirectory listings 411, the viewer can select the Playlist Subdirectory 414 options as illustrated in FIG. 32. The system subsequently presents a Playlist Options Listing 580 comprising a Lock Subdirectories Listings 452, a Watched Playlist 584, a Favorites Playlist 586, and the like. The user can select any of the options to proceed to that specific Playlist.

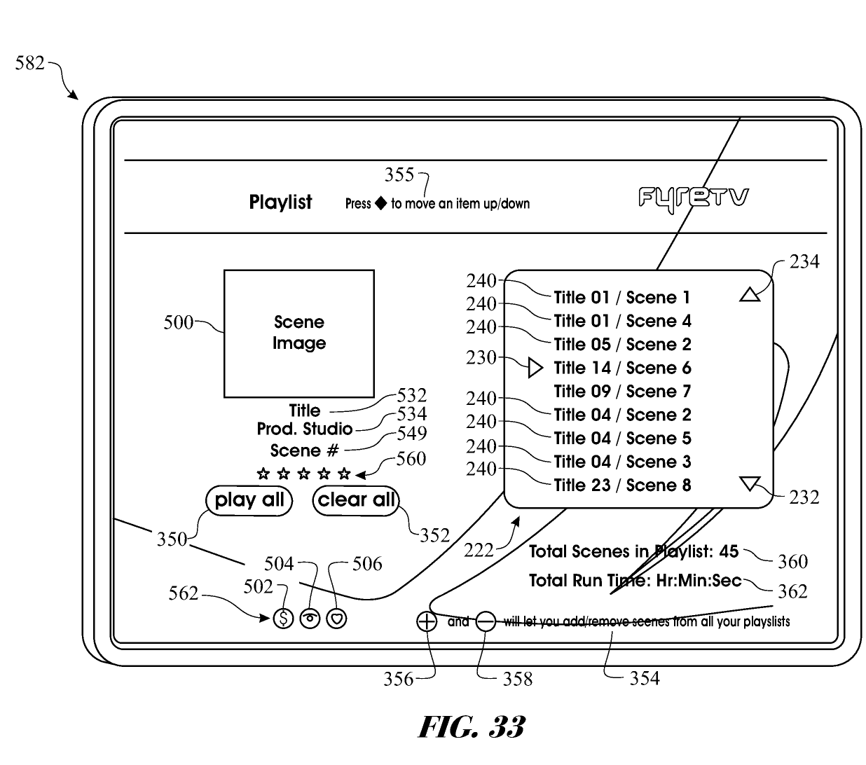

A current Playlist 582 can be presented in the exemplary format illustrated in FIG. 33. The Playlist 222 allows the user to play an entire series of fragments associated with the Title and Scene reference 240 within the Playlist 222. The current Playlist 582 allows the user to manipulate the Playlist 222 by adding a title and scene reference 240 via an add to Playlist action 356, removing a title and scene reference 240 via a remove from Playlist action 358, or changing the order via an Adjust Play Order Instruction 355. Details of the Add to Playlist action 356 and Remove from Playlist action 358 can be communicated to the viewer via an Amend Playlist Instructions 354. The viewer can use the Title Indicator 230 to select an individual Title and Scene reference 240 for viewing or select a Play All Button 350 to play the complete list. The viewer can opt to select a Clear All Button 352 to delete all of the Title and Scene References 240 within the Playlist 222. When the user positions the Title Indicator 230 adjacent a Title and Scene Reference 240, the video image 500 can begin playing in a preview window. Information pertaining to the selected Title and Scene Reference 240 can be displayed. The exemplary information can include the Video Title 532, the Production Studio 534, the Scene Number 549, and the Rating 560 respective to the highlighted Title and Scene reference 240. Other exemplary features that can be offered include a total number of Scenes in Playlist 360, a total time of the Playlist 362, and Playlist Indicators 562. It is recognized the viewer can maintain a plurality of Playlists 222.

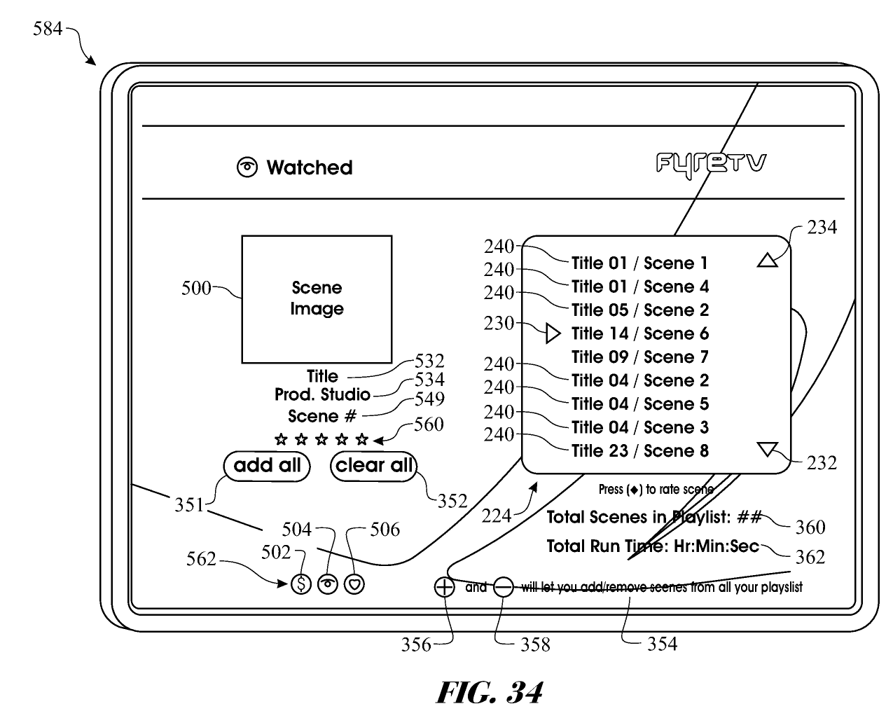

A Watched Playlist 584 is similar to the current Playlist 582 of FIG. 33. The Watched Playlist 584 is presented in the exemplary format illustrated in FIG. 34. In the preferred configuration, the viewer would watch the videos via the Current Playlist 582. The Watched Playlist 584, and similarly with the Favorites Playlist 586, are provided allowing the user to manipulate and utilize additional listings of Title and Scene References 240. One distinction between the Watched Playlist 584/Favorites Playlist 586 and the Current Playlist 582 is that the Watched Playlist 584/Favorites Playlist 586 comprises an Add All Button 351.

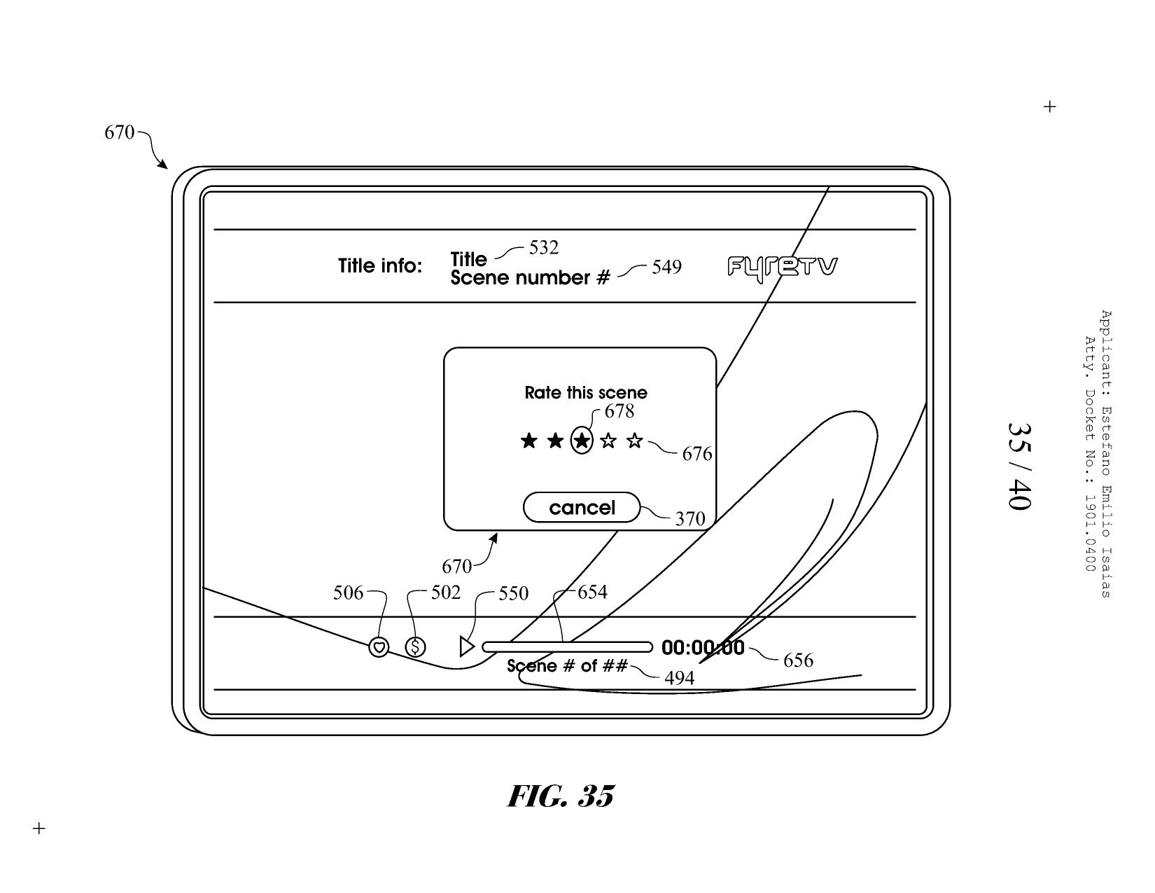

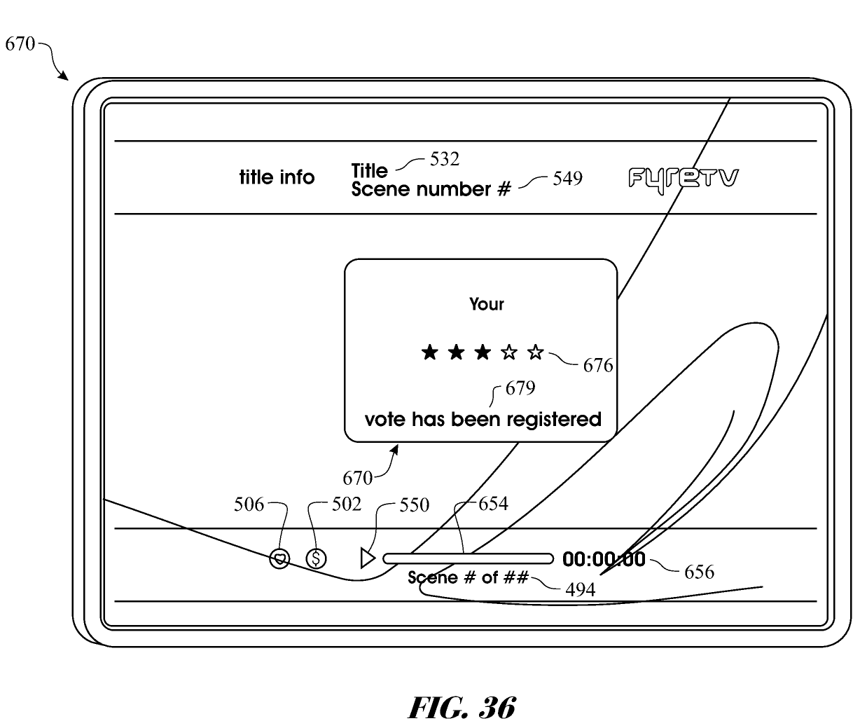

In some embodiments, while viewing a Video or Video Fragment, the viewer can select the Function Button 198 of the remote control 170 (or similar operative) to direct to an alternate rating selection 670 as illustrated in FIG. 35. In the exemplary embodiment, the viewer can rate the Video or Video Fragment using a rating selection string 676. The user would use Left/Right Control Functions, such as the Forward/Fast-Forward Button 182 and Rewind Fast-Rewind Button 184 of the remote control 170 to move the viewer selected rating 678 to adjust the number of stars to rate the video or video fragment. The user can enter the rating via any reasonable method, such as by selecting the Select Entry Button 176 of the remote control 170. If the user no longer desires to submit or change a rating of a Video or Video Fragment, the system offers a Cancel Button 370. Alternately, the user can select the Play Scene Button 550 to return to the Video or Video Fragment. The screen format can include any of the desired information, including the Video Title 532 and the Scene Number 549. If the Fragment is one of a series of Fragments, the Category Selection Instructions 494 may be presented. The format can include any of the Playlist indicators respective to the video. The format can include the fee related 502 icon. The screen can present the video portion viewed graphic 654 and numeric time of video portion viewed 656 to indicate how much Video or Video Fragment has been played. Once a rating has been entered, the rating selection 670 indicates the vote as being registered such as via a rating submission verification 679 shown in the exemplary embodiment of FIG. 36.

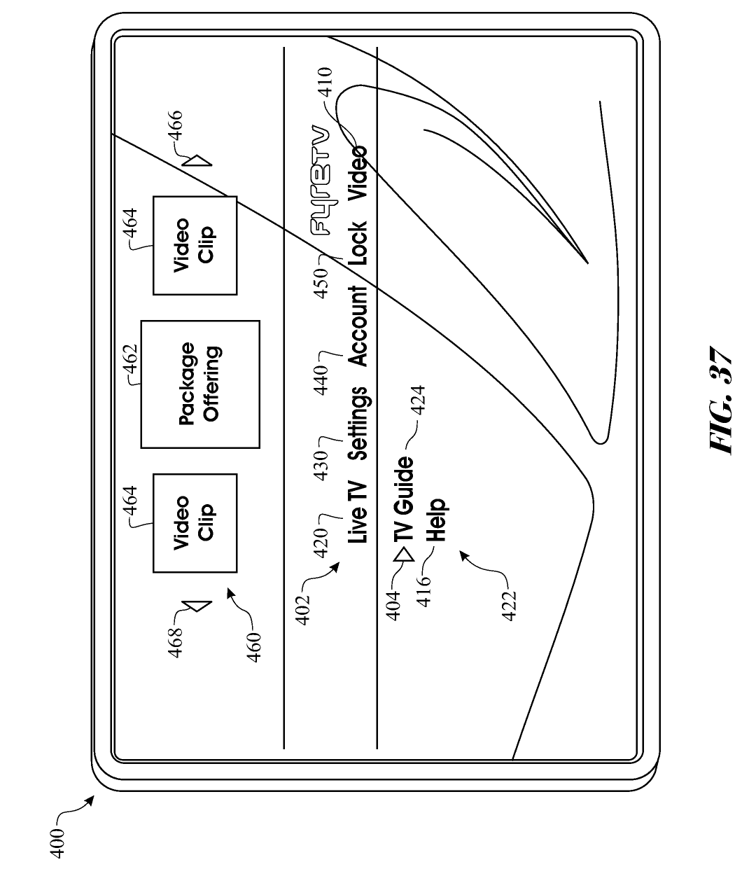

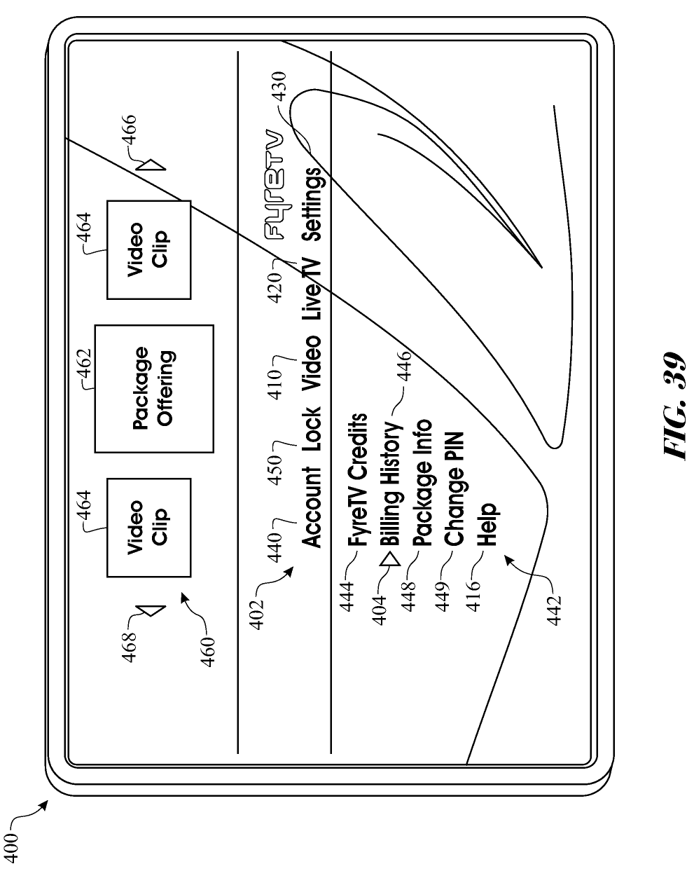

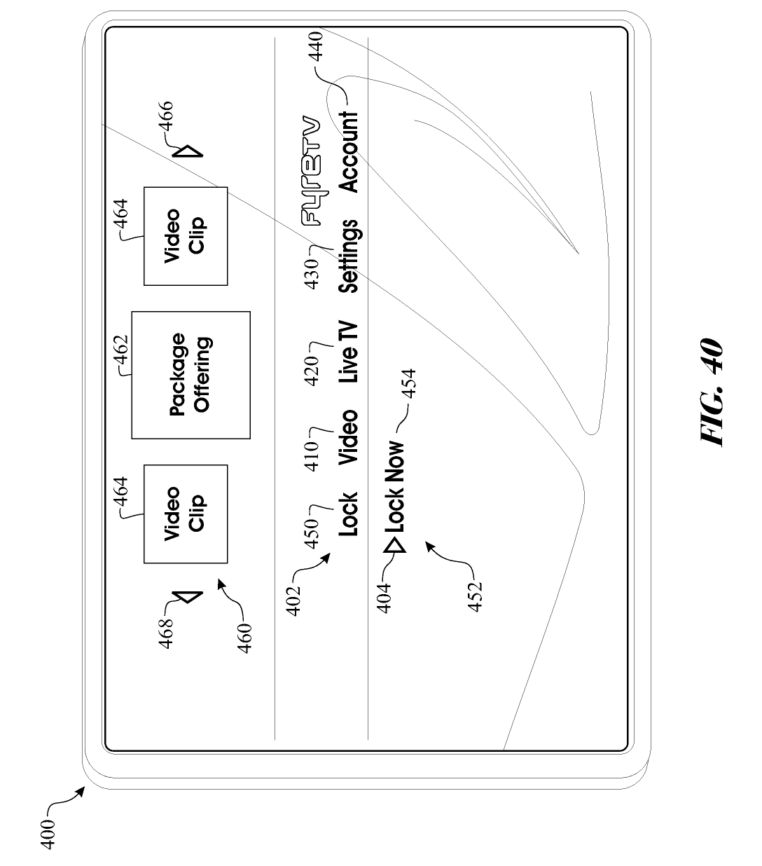

Additional operative features of the system are presented in FIGS. 37 through 40. The Live TV Directory 420 offers the viewer options in a live TV Subdirectories Listing 422 comprising a TV guide 424 and the help link 416 as shown in FIG. 37. The TV guide 424 option directs the user to various viewing options and scheduling.

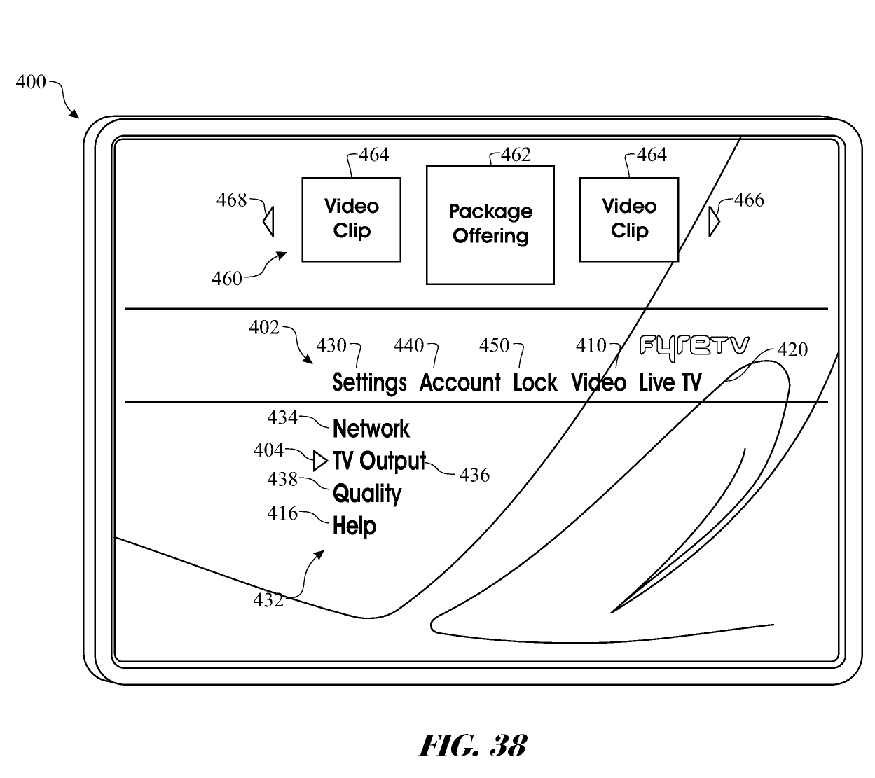

The settings directory 430 offers the viewer options in a Settings Subdirectories Listing 432 comprising a Network 434, a TV Output 436, a Quality 438 and the Help link 416 as shown in FIG. 38. These options provided the user with the interfaces for adjusting the settings of the system. The user can change the settings of the network, the TV output format, the video quality, and any other setting as needed, under this heading.

The Account Directory 440 provides the user with access to interfaces pertaining to the viewer's specific account information. Examples of optional items are presented in an Account Directories Listing 442, including Credits 444, Billing History 446, Package Information 448, a Change Personal Identification Number (PIN) 449, and the Help Link 416. The Credit 444 provides the user with an account balance. The Billing History 446 provides the user access and information pertaining to their specific Billing History. The package information 448 provides the user with access to available as well as purchased packages. The Change Personal Identification Number (PIN) 449 allows the user the ability to change their PIN number.

Particularly for use in connection with the preferred Adult Entertainment video implementation of the system, a Lock Now command feature 454 is provided under the Lock Subdirectory Directory 450, which, when selected, immediately blocks access to the system until the PIN Code is re-entered. In this manner, a system user can ensure that access to the system, for example by minors, is blocked.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. An audio-video recording distribution system for creating, manipulating and distributing video segments in a manner facilitating subsequent video segment searching, organizing and viewing by an end user in order to optimize the viewing experience, the system comprising:
a video distribution center, including a database server;
at least one search index file stored on the database server and including a series of video content related identifiers;
a length of video containing a continuous stretch of video content partitioned into a series of consecutive individual video segments, each video segment stored on the database server as an individual video segment file;
each said video segment file having associated therewith information/values corresponding to the video content related identifiers of the search index file;
an end user viewing interface remote from, but in two-way communication with, the video distribution center, the viewing interface comprising:
computer operated software including a graphical user interface;
a user interface control unit in communication with the computer operated software, the user interface control unit facilitating end user selection of preferred information/values corresponding to at least some of the video content related identifiers of the search index file;
a search routine facilitating selection by the end user viewer of said preferred information/values corresponding to said video content related identifiers, wherein the preferred information/values are used to determine at least one viewer preferred video segment; and
an output interface for displaying said at least one viewer preferred video segment on a viewer display.

2. An audio-video recording distribution system as recited in claim 1, further comprising:
a controller interface unit comprising an electronic identifier communicable to the video distribution center for comparative validation against an approved listing of electronic identifiers for access approval.

3. An audio-video recording distribution method for distributing video segments in a manner facilitating subsequent video segment searching, organizing and viewing by an end user in order to optimize the viewing experience, the method comprising steps of:
obtaining a complete audio-video recording;
partitioning said complete audio-video recording into a plurality of consecutive audio-video fragments;
storing each of said audio-video fragments on a database server;
establishing a search index file comprising a plurality of predetermined video reference and content information categories and storing said search index file on at least one of an index server and a database server, wherein the video content information categories correspond to category data that are identifiable for each of said plurality of audio-video fragments;
associating category data for all of the audio-video fragments in a manner enabling the end user to perform a Boolean search to return a listing of audio-video fragments meeting an end user defined set of search criteria; and
providing a viewing party with remote access to said search index file and associated data in order to perform a desired search.

4. An audio-video recording distribution method as recited in claim 3, wherein the step of establishing said search index file further comprises establishing a plurality of categories, each category comprising at least one subcategory having at least one reference/value.

5. An audio-video recording distribution method as recited in claim 3, further comprising the steps of:
establishing a video start marker and a video stop marker to define a desired segment of said audio-video recording; and
storing said video start marker and video stop marker in a manner enabling the end user viewer to view said desired segment in a repeatable manner.

6. An audio-video recording distribution method as recited in claim 3, further comprising the steps of:
rating at least one audio-video fragment by the viewing party;
uploading said rating to said video distribution center;
uploading an identifier associated with said viewing party to the video distribution center;
storing said rating within the video distribution center, the rating stored in a manner associated with the viewing party; and
creating an average rating of all ratings submitted.

7. An audio-video recording distribution method as recited in claim 6, further comprising the steps of including said average rating in said search index file.

8. An audio-video recording distribution method as recited in claim 3, further comprising the steps of:
selecting a plurality of video category identifiers from said predetermined video reference and content information categories to create a selected category summary; and
utilizing said selected category summary to determine and return a listing of audio-video fragments meeting said set of search criteria.

9. An audio-video recording distribution method as recited in claim 8, further comprising the step of including at least one exclusive video category identifier in the selected category summary, wherein said Boolean search returns a listing which includes all of the selected video category identifiers and excludes a subset of said listing which includes an association with any of said at least one exclusive video category identifier.

10. An audio-video recording distribution method as recited in claim 3, further comprising the step of presenting said listing of video fragments as a series of clip previews.

11. An audio-video recording distribution method as recited in claim 3, further comprising the steps of:
maintaining a playlist of audio-video fragments selected by said viewing party on said database server; and
providing said viewing party access to said playlist.

12. An audio-video recording distribution method for distributing video segments in a manner facilitating subsequent video segment searching, organizing and viewing by an end user in order to optimize the viewing experience, the method comprising steps of:
obtaining a complete audio-video recording;
partitioning said complete audio-video recording into a plurality of consecutive audio-video fragments;
storing each of said audio-video fragments on a database server;
establishing a search index file comprising a plurality of predetermined video reference and content information categories and storing said search index file on at least one of an index server and a database server, wherein the video content information categories correspond to category data that are identifiable for each of said plurality of audio-video fragments;
establishing a set of search criteria by selecting at least one of desired and undesired predetermined video reference and content information categories from said search index file;
associating category data for all of the audio-video fragments in a manner enabling the end user to perform a Boolean search to return a listing of audio-video fragments meeting set of search criteria; and
providing a viewing party with remote access to said search index file and associated data in order to perform a desired search.

13. An audio-video recording distribution method as recited in claim 12, further comprising the step of establishing a set of search criteria by selecting at least one desired predetermined video reference and content information category and at least one undesired predetermined video reference and content information category from said search index file.

14. An audio-video recording distribution method as recited in claim 12, further comprising the step of presenting said displaying the list of video fragments as a series of clip previews.

15. An audio-video recording distribution method as recited in claim 12, further comprising the steps of:
maintaining a playlist of audio-video fragments selected by said viewing party on said database server; and
providing said viewing party access to said playlist.

16. An audio-video recording distribution method as recited in claim 12, further comprising the steps of:
rating at least one audio-video fragment by the viewing party;
uploading said rating to said video distribution center database server;
uploading an identifier associated with said viewing party to the video distribution center database server;
storing said rating in a manner associated with said viewing party; and
creating an average rating of all ratings submitted.

17. An audio-video recording distribution method as recited in claim 16, further comprising the step of including said average rating in said search index file.

18. An audio-video recording distribution method as recited in claim 12, further comprising the steps of:
establishing a video start marker and a video stop marker to define a desired segment of said audio-video recording; and
storing said video start marker and video stop marker in a manner enabling the end user viewer to view said desired segment in a repeatable manner.
